(19) United States
(12) Patent Application Publication
(10) Pub. No.: US 2026/0177939 A1
(43) Pub. Date: Jun. 25, 2026

(54) TONER, DEVELOPING AGENT, TONER ACCOMMODATING UNIT, IMAGE FORMING APPARATUS, IMAGE FORMING METHOD, METHOD OF PRODUCING PRINTED MATERIAL, AND METHOD OF MANUFACTURING TONER

(71) Applicants: Shimpei Miyata, Tokyo (JP); Yoshitaka Yamauchi, Shizuoka (JP); Hisashi Nakajima, Shizuoka (JP); Ayaka Mori, Shizuoka (JP); Masayuki Ishii, Shizuoka (JP)

(72) Inventors: Shimpei Miyata, Tokyo (JP); Yoshitaka Yamauchi, Shizuoka (JP); Hisashi Nakajima, Shizuoka (JP); Ayaka Mori, Shizuoka (JP); Masayuki Ishii, Shizuoka (JP)

(73) Assignee: Etria Co., Ltd., Kanagawa (JP)

(21) Appl. No.: 19/424,475

(22) Filed: Dec. 18, 2025

(30) Foreign Application Priority Data
Dec. 20, 2024 (JP) 2024-225309

(51) Int. Cl. G03G 9/087; G03G 9/08; G03G 9/107

(52) U.S. Cl. CPC G03G 9/08755; G03G 9/0802; G03G 9/0819; G03G 9/08775; G03G 9/108

(57) ABSTRACT

A toner contains toner particles that contains a polyester resin, an aromatic petroleum resin, and a release agent, wherein cross sections of the toner particles observed with a scanning electron microscope have domains of the release agent that satisfy the following requirements (i) and (ii):
(i) the average number of the domains present per toner particle is 2 to 8; and
(ii) each of the domains has a long diameter of at least 400 nm and an aspect ratio of at most 0.7 as calculated by Formula 1:

Aspect ratio=(short diameter of domain)/(long diameter of domain) Formula 1.

### CROSS-REFERENCE TO RELATED APPLICATIONS

This patent application is based on and claims priority pursuant to 35 U.S.C. § 119 to Japanese Patent Application No. 2024-225309 filed on Dec. 20, 2024, in the Japan Patent Office, the entire disclosure of which is hereby incorporated by reference herein.

### BACKGROUND

### Technical Field

The present disclosure is related to a toner, a toner accommodating unit, an image forming apparatus, an image forming method, a method of producing a printed material, and a method of manufacturing a toner.

### Description of the Related Art

Traditionally, electrophotographic apparatuses and electrostatic recording apparatuses visualize latent electrical or magnetic images using toner for developing electrostatic latent images (referred to as toner in the present disclosure). For example, in the electrophotography, electrostatic latent images are formed on a photoconductor (also referred to as electrostatic latent image bearer in the present disclosure) and developed with toner to form toner images. The toner image is transferred to a recording medium, typically paper, and thereafter fixed thereon by methods such as heating.

In recent years, there has been a demand for toner fixable at lower temperatures to reduce the energy required for fixing, thereby achieving energy savings. Moreover, coupled with the diversification in usage of image forming apparatuses, these apparatuses are demanded to achieve higher performance while producing higher quality images. As a method of enhancing the low temperature fixability of toner, techniques using a combination of amorphous polyester resin and crystalline polyester resin are known.

### SUMMARY

The present disclosure described herein provides a toner contains toner particles that contains a polyester resin, an aromatic petroleum resin, and a release agent, wherein cross sections of the toner particles observed with a scanning electron microscope have domains of the release agent that satisfy the following requirements (i) and (ii):
(i) the average number of the domains present per toner particle is 2 to 8; and
(ii) each of the domains has a long diameter of at least 400 nm and an aspect ratio of at most 0.7 as calculated by Formula 1:

$$Aspect ratio = ( short diameter of domain ) / ( long diameter of domain ) . \qquad Formula 1$$

As another aspect of the present disclosure, a developing agent is provided which contains the toner mentioned above and a carrier.

As another aspect of the present disclosure, a toner accommodating unit is provided which contains the toner mentioned above and a container containing the toner.

As another aspect of the present disclosure, an image forming apparatus is provided which includes an electrostatic latent image bearer, an electrostatic latent image forming device to form an electrostatic latent image on the electrostatic latent image bearer, a developing device to develop the electrostatic latent image on the electrostatic latent image bearer with the toner mentioned above to form a toner image, a transfer device to transfer the toner image onto a surface of a recording medium, and a fixing device to fix the toner image on the surface of the recording medium.

As another aspect of the present disclosure, an image forming method is provided which includes forming an electrostatic latent image on an electrostatic latent image bearer, developing the electrostatic latent image formed on the electrostatic latent image bearer with the toner mentioned above to form a toner image on the electrostatic latent image bearer, transferring the toner image formed on the electrostatic latent image bearer to a surface of a recording medium, and fixing the toner image on the surface of the recording medium.

As another aspect of the present disclosure, a method of producing a printed material includes forming an image on a recording medium with the image forming apparatus mentioned above to produce the printed material.

As another aspect of the present disclosure, a method of producing a printed material includes forming an image on a recording medium with the image forming apparatus of Aspect 9 mentioned above to produce the printed material.

As another aspect of the present disclosure, a method of manufacturing the toner mentioned above, includes adding 7 to 9.5 parts by mass of the base toner particle to 100 parts by mass of the base toner particle to manufacture a base toner particle containing the polyester resin and the aromatic petroleum resin.

### BRIEF DESCRIPTION OF THE SEVERAL VIEWS OF THE DRAWINGS

A more complete appreciation of the disclosure and many of the attended advantages and features thereof can be readily obtained and understood from the following detailed description with reference to the accompanying drawings wherein:

FIG. 1 is a schematic diagram illustrating an example of an image forming apparatus;

FIG. 2 is a schematic diagram illustrating an example of the developing device;

FIG. 3 is a diagram illustrating an example of the image forming apparatus including the developing device illustrated in FIG. 3;

FIG. 4 is a diagram illustrating another example of the image forming apparatus; and

FIG. 5 is a diagram illustrating another example of the image forming apparatus.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more the features, integers, steps, operations, elements, components, and/or groups thereof.

Embodiments of the present invention are described in detail below with reference to accompanying drawings. In describing embodiments illustrates in the drawings, specific terminology is employed for the sake of clarity. However, the disclosure of this patent specification is not intended to be limited to the specific terminology so selected. And it is to be understood that each specific element includes all technical equivalents that have a similar function, operates in a similar manner, and achieve a smaller result.

For the sake of simplicity, the same reference number will be given to identical constituent elements such as parts and materials having the same functions and redundant descriptions thereof omitted unless otherwise stated.

Within the context of the present disclosure, it a first layer is stated to be “overlaid” on, or “overlying” a second layer, the first layer may be in direct contact with a portion or all of the second layer, or there may be one or more intervening layers between the first and second layer, with the second layer being close to the substrate than the first layer.

According to the present disclosure, a toner is provided which exhibits excellent low-temperature fixability, while achieving a balance between suppressing filming under severe conditions such as high temperature and humidity and maintaining releasability during fixing.

Typical toners, including the toners described in Japanese Unexamined Patent Application Publication No. 2005-62599 and Japanese Unexamined Patent Application Publication No. 2021-144186, and Japanese Unexamined Patent Application Publication No. 2023-47237 mentioned above raise concerns about image defects caused by filming, which occurs when low-heat-resistant wax or polyester resin exposed on the toner surface adheres to the photoconductor. This issue is particularly pronounced in high-temperature and high-humidity environments and causes image defects more when the printing area is small. On the other hand, if the amount of wax used is reduced, releasability during fixing becomes an issue. Achieving both suppression of filming under high-temperature and high-humidity conditions and releasability during fixing has been a challenge.

In contrast to the above typical technologies, the toner contains toner particles that contains a polyester resin, an aromatic petroleum resin, and a release agent, wherein cross sections of the toner particles observed with a scanning electron microscope have domains of the release agent that satisfy the following requirements (i) and (ii):
(i) the average number of the domains present per toner particle is 2 to 8; and
(ii) each of the domains has a long diameter of at least 400 nm and an aspect ratio of at most 0.7 as calculated by Formula 1:

$$Aspect ratio = ( short diameter of domain ) / ( long diameter of domain ) . \qquad Formula 1$$

More specifically, the toner of the present disclosure, which satisfies the requirements above, exhibits excellent low temperature fixability while achieving both suppression of filming under high-temperature and high-humidity conditions and releasability during fixing. The domains of the release agent is also referred to as the release agent domains.

The present disclosure is described in detail below.

### Toner

The toner of the present disclosure contains a polyester resin, a release agent, and a aromatic petroleum resin, along with other optional components such as a colorant and an external additive.

The toner of the present disclosure contains toner particles satisfying the following requirements (i) and (ii) when their cross section is observed.
(i) the average number of the domains of the release agent present per toner particle is 2 to 8; and
(ii) each of the domains has a long diameter of at least 400 nm and an aspect ratio of at most 0.7 as calculated by Formula 1:

$$Aspect ratio = ( short diameter of release agent domain ) / ( long diameter of release agent domain ) . \qquad Formula 1$$

It is preferable that the toner particles contain release agent domains having a major axis of at least 400 nm and an aspect ratio greater than 0.5 and the average number of the domains of the release agent present per toner particle be 2 to 5.

In the present disclosure, when the cross section of each of the toner particles is observed, each includes a release agent domain having a major axis of at least 400 nm and an aspect ratio of at most 0.7.

When toner particles contain release agent domains having a major axis of at least 400 nm and an aspect ratio greater than 0.7, the particles are likely to deform during storage due to the release agent domains, which leads to deterioration in toner fluidity and increased toner agglomeration. Furthermore, particularly under high temperature and high humidity conditions, toner may adhere to the photoconductor during actual image formation, causing problems such as filming. The presence of release agent domains with an aspect ratio of at most 0.7 serves to inhibit filming caused by exposure of the release agent domains on the toner surface during pulverization.

### Polyester Resin

The polyester resin for use in the present disclosure is not particularly limited and can be suitably selected according to a particular application. The weight average molecular weight (Mw) is preferably from 7000 to 10000, more preferably from 7500 to 9500, and furthermore preferably from 8000 to 9000. A molecular weight of at least 7000 serves to reduce degradation of hot offset resistance attributable to low molecular weight components.

A molecular weight of at most 10000 serves to reduce deterioration in wax dispersibility attributable to high molecular weight components.

In addition, the ratio of the weight average molecular weight (Mw)/the number average molecular weight (Mn) is at most 5 and preferably at most 4. In addition, the ratio of the average molecular weight of the polymers is preferably at least 1 and more preferably at least 2. A Mw/Mn ratio of the polyester resin of at least 1 enables stable fixing performance over a wide temperature range from low to high temperatures, and a ratio of at most 5 makes it possible to suppress the occurrence of quality issues attributable to extremely low or high molecular weight components.

The polyester resin for use in the toner of the present disclosure is not particularly limited and may be appropriately selected according to a particular application. From the viewpoint of low temperature fixability and from the standpoint of designing fixing performance and gloss, it is preferable to use a mixture of a crystalline polyester resin and an amorphous polyester resin.

### Crystalline Polyester Resin

The crystalline polyester resin has a high crystallinity, thereby exhibiting a heat-melt property demonstrating a sharp change in viscosity around the fixing starting temperature. Such a crystalline polyester resin in combination with an amorphous polyester resin provides good heat storage stability attributable to crystallinity up to immediately before the melting onset temperature, and at the melting onset temperature, its viscosity sharply decreases, exhibiting sharp-melting behavior as a result of melting of the crystalline polyester resin. Consequently, this behavior compatibilizes the crystalline polyester resin with the amorphous polyester resin, leading to production of toner with excellent high-temperature storage stability and low-temperature fixing properties. This behavior also provides an excellent release width (the difference between the lower limit fixing temperature and the temperature at which high-temperature offset occurs).

The crystalline polyester resin is prepared by a polyol with a polycarboxylic acid, a polycarboxylic anhydride, polycarboxylic acid ester, or their derivatives.

In the present disclosure, the crystalline polyester resin refers to a substance obtained by using a polyol and a polycarboxylic acid, a polycarboxylic anhydride, polycarboxylic acid ester, or their derivatives as described above. The crystalline polyester resin excludes modified polyester resin obtained by the prepolymer which is described later and resin obtained by cross-linking and/or elongating the prepolymer.

### Polyhydric Alcohol

The polyhydric alcohol is not particularly limited and can be suitably selected according to a particular application. Examples include, but are not limited to, diol and tri- or higher alcohols.

One example of diol is saturated aliphatic diol. Examples of the saturated aliphatic diol include, but are not limited to, linear saturated aliphatic diols and branched saturated aliphatic diols. Of these, linear saturated aliphatic diols are preferred to prevent the lowering of the melting point due to a decrease in the crystallinity. From the viewpoint of availability, linear saturated aliphatic diols with 2 to 12 carbon atoms are more preferred.

Specific examples of the saturated aliphatic diol include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosandecanediol. Of these, ethylene glycol, 1,4-butanediol, 1,6-hexanediol, 1,8-octanediol, 1,10-decanediol, and 1,12-dodecanediol are preferable to enhance crystallinity of the crystalline polyester resin and achieve excellent sharp melting thereof.

These can be used alone or in combination.

Specific examples of the tri- or higher alcohol include, but are not limited to, glycerin, trimethylol ethane, trimethylol propane, and pentaerythritol. These alcohols can be used alone or in combination.

### Polycarboxylic Acid

The polycarboxylic acid mentioned above is not particularly limited and can be suitably selected according to a particular application. Examples include, but are not limited to, dicarboxylic acid and tri- or higher carboxylic acid. These dicarboxylic acids can be used alone or in combination.

Specific examples of dicarboxylic acids include, but are not limited to, saturated aliphatic dicarboxylic acid such as oxalic acid, succinic acid, glutaric acid, adipic acid, suberic acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, and 1,18-octadecane dicarboxylic acid and aromatic dicarboxylic acids of diprotic acids including phthalic acid, isophthalic acid, terephthalic acid, naphthalene-2,6-dicarboxylic acid, malonic acid, and mesaconic acid. They also include anhydrides or lower alkylesters (1 to 3 carbon atoms) thereof.

Specific examples of the tri- or higher carboxylic acids include, but are not limited to, 1,2,4-benzene tricarboxylic acid, 1,2,5-benzene tricarboxylic acid, and 1,2,4-naphtalene tricarboxylic acid. They also include anhydrides or lower alkylesters (1 to 3 carbon atoms) thereof.

In addition to the saturated aliphatic dicarboxylic acid and the aromatic dicarboxylic acid, a dicarboxylic acid having a sulfonic acid group and a dicarboxylic acid having a double bond can be used as the polycarboxylic acid.

The crystalline polyester resin is preferably formed of a linear saturated aliphatic dicarboxylic acid with 4 to 12 carbon atoms and a linear saturated aliphatic diol with 2 to 12 carbon atoms. In other words, the crystalline polyester resin preferably contains structural units derived from a saturated aliphatic dicarboxylic acid with 4 to 12 carbon atoms and structural units derived from a saturated aliphatic diol with 2 to 12 carbon atoms. This crystalline polyester resin thus demonstrates high crystallinity and excellent sharp melting, thereby achieving excellent low temperature fixability, which is preferable.

The melting point of the crystalline polyester resin is not particularly limited and can be suitably selected according to a particular application. It is preferably from 60 to 80 degrees Celsius.

A melting point of the crystalline polyester resin of 60 or higher degrees Celsius is preferable because it can prevent a decrease in the high temperature storage stability of the toner due to the crystalline polyester resin melting at low temperatures.

A melting point of the crystalline polyester resin of 80 or lower degrees Celsius is preferable because it can prevent a decrease in the low-temperature fixability of the toner due to insufficient melting of the crystalline polyester resin during the fixing process.

The molecular weight of the crystalline polyester resin is not particularly limited and can be suitably selected according to a particular application. It is to be noted that while lower molecular weight components with a sharp distribution exhibits excellent low temperature fixability, an excess of these components may compromise high temperature storage stability. Therefore, the soluble fraction of the crystalline polyester resin in ortho-dichlorobenzene, as measured by gel permeation chromatography (GPC), is preferably within a range of weight-average molecular weight Mw of 3,000 to 30,000, number-average molecular weight Mn of 1,000 to 10,000, and Mw/Mn ratio of 1.0 to 10.

Furthermore, it is more preferable that the soluble fraction of the crystalline polyester resin in ortho-dichlorobenzene, as measured by gel permeation chromatography (GPC), has a weight average molecular weight Mw of 5,000 to 15,000, a number average molecular weight Mn of 2,000 to 10,000, and an Mw/Mn ratio of 1.0 to 5.0.

The number average molecular weight Mn and the weight average molecular weight Mw can be measured with gel permeation chromatography (GPC), for example, under the following conditions:

### Measurement Condition

An example of device: HLC-8120, available from TOSOH CORPORATION
An example of column: TSK GEL GMH6, available from TOSOH CORPORATION, two columns
Measuring temperature: 40 degrees Celsius
Sample solution: 0.25 percent by mass tetrahydrofuran solution (non-dissolved portion filtered with glass filter)
Amount of solution infused: 100 μL
Detector: Refractive index detector
Reference materials: Standard polystyrene (TSK standard polystyrene) with 12 materials (molecular weights: 500, 1,050, 2,800, 5,970, 9,100, 18,100, 37,900, 96,400, 190,000, 355,000, 1,090,000, and 2,890,000) (available from TOSOH CORPORATION)

The acid value of the crystalline polyester resin is not particularly limited and can be suitably selected according to a particular application. It is preferably at least 5 mgKOH/g, and more preferably at least 10 mgKOH/g to achieve target low temperature fixing properties in terms of affinity between the recording medium (typically paper) described later and the resin. Conversely, to enhance the hot offset resistance, the acid value is preferably at most 45 mgKOH/g.

The hydroxyl value of the crystalline polyester resin is not particularly limited and can be suitably selected according to a particular application. It is preferably 0 to 50 mgKOH/g and more preferably 5 to 50 mgKOH/g to achieve target low temperature fixing performance and good chargeability.

The molecular structure of the crystalline polyester resin can be analyzed in solution or solid state using NMR, along with other methods such as X-ray diffraction, GC/MS, LC/MS, and infrared (IR) absorption. A simple method of detecting a crystalline polyester resin involves identifying substances that exhibit absorption based on the δCH (out-of-plane vending vibration) of olefins at 965 cm⁻¹±10 cm⁻¹ or 990 cm⁻¹±10 cm⁻¹ in the infrared absorption spectrum as crystalline polyester resin.

The proportion of the crystalline polyester resin is not particularly limited and can be suitably selected according to a particular application. The number of parts of the crystalline polyester resin is preferably from 3 to 20 parts by mass and more preferably from 5 to 15 parts by mass to 100 parts of the toner mentioned above.

If the content of the crystalline polyester resin is at least 3 parts by mass per 100 parts by mass of the toner, the crystalline polyester resin can achieve sharp melting, leading to good low-temperature fixability, which is preferable.

If the content of the crystalline polyester resin is not more than 20 parts by mass per 100 parts by mass of the toner, high temperature storage stability is improved, resulting in high-quality images, which is preferable.

### Non-Crystalline Polyester Resin

The amorphous polyester resin mentioned above is not particularly limited and crystalline polyester resin. For example, amorphous polyester resin A, with a glass transition temperature (Tg) of −40 to 20 degrees Celsius, and non-crystalline polyester resin B, with a glass transition temperature (Tg) of 40 to 80 degrees Celsius, can be listed.

### Amorphous Polyester Resin

The amorphous polyester resin A is not particularly limited as long as its glass transition temperature (Tg) is −40 to 20 degrees C., and can be suitably selected according to a particular application.

It is preferable for the amorphous polyester resin A to be obtained by the reaction between a non-linear reactive precursor and a curing agent.

Additionally, it is preferable for the amorphous polyester resin A to have at least one of urethane bonds and urea bonds, as it exhibits better adhesion to recording media such as paper. The urethane bonds or urea bonds in the amorphous polyester resin A show behavior similar to pseudo-crosslinking, enhancing the rubber-like properties of the amorphous polyester resin A and improving the high temperature storage stability and resistance to high-temperature offset of the toner.

### Non-Linear Reactive Precursor

The non-linear reactive precursor may be any polyester resin (referred to as a prepolymer hereafter) having reactive groups capable of reacting with a curing agent, without particular limitations, and can be appropriately selected according to a particular application. Non-linear refers to a branched structure resulting from the presence of at least one tri- or higher alcohol or tri- or higher carboxylic acid.

In the case where the reactive precursor in the aforementioned amorphous polyester resin A is non-linear, it has a branched structure in the molecular skeleton, resulting in a three-dimensional network of molecular chains. This structure imparts rubber-like properties, allowing itself to deform at low temperatures without flowing. Therefore, it becomes possible to maintain the heat resistance storage stability and resistance to high-temperature offset of the toner.

One example of a reactive group within the prepolymer that is capable of reacting with the curing agent is a group that can react with an active hydrogen group. Specific examples of the group reactive with an active hydrogen group include, but are not limited to, an isocyanate group, an epoxy group, a carboxylic acid, and an acid chloride group. Of these, an isocyanate group is preferable to introduce a urethane or urea bond into an amorphous polyester resin.

As the prepolymer, a polyester resin containing an isocyanate group is preferable.

The polyester resin containing an isocyanate group is not particularly limited and can be suitably selected according to a particular application. One example is a reaction product of a polyisocyanate and a polyester resin with an active hydrogen group. One way of obtaining a polyester resin with an active hydrogen group involves polycondensing a diol with a dicarboxylic acid or, or polycondensing a tri- or higher alcohol with a tri- or higher carboxylic acid. Polycondensation of a tri- or higher alcohol and a tri- or higher carboxylic acid results in a branch-structured polyester resin with an isocyanate group.

The diols are not particularly limited and can be suitably selected according to a particular application.

Specific examples include, but are not limited to, aliphatic diols such as ethylene glycol, 1,2-propylene glycol, 1,3-propylene glycol, 1,4-butanediol, 1,5-pentanediol, 1,6-hexanediol, 1,8-octanediol, 1,10-decanediol, and 1,12-dodecanediol; diols having oxyalkylene groups such as diethylene glycol, triethylene glycol, dipropylene glycol, polyethylene glycol, polypropylene glycol and polytetramethylene ether glycol; alicyclic diols such as 1,4-cyclohexane dimethanol and hydrogenated bisphenol A; adducts of alicyclic diols with an alkylene oxide such as ethylene oxide, propylene oxide, and butylene oxide; bisphenols such as bisphenol A, bisphenol F, and bisphenol S; and adducts of bisphenols with an alkylene oxide such as ethylene oxide, propylene oxide, and butylene oxide. Of these, aliphatic diols with 4 to 12 carbon atoms are preferable.

These diols can be used alone or in combination.

The dicarboxylic acid is not particularly limited and can be suitably selected according to a particular application. It includes an aliphatic dicarboxylic acid and an aromatic dicarboxylic acid, for example. Their anhydrides, lower (1 to 3 carbon atoms) alkylester compounds, or halogenated compounds can be also used.

The aliphatic dicarboxylic acids are not particularly limited and can be suitably selected according to a particular application. Specific examples include, but are not limited to, succinic acid, adipic acid, sebacic acid, dodecanedioic acid, maleic acid, and fumaric acid.

The aromatic dicarboxylic acids are not specifically restricted and can be chosen as needed for the purpose. It is preferably aromatic dicarboxylic acids with 8 to 20 carbon atoms. For aromatic dicarboxylic acids with 8 to 20 carbon atoms, there are no specific restrictions, and they can be chosen as needed for the purpose. Examples include, but are not limited to, phthalic acid, isophthalic acid, terephthalic acid, and naphthalenedicarboxylic acid.

Of these, aliphatic dicarboxylic acids with 4 to 12 carbon atoms are preferable. These dicarboxylic acids can be used alone or in combination.

This tri- or higher-valent alcohol is not particularly limited and can be suitably selected according to a particular application. It includes a tri- or higher-valent aliphatic alcohol, a tri- or higher-valent polyphenol, and an adduct of polyphenol with alkylene oxide.

Specific examples of tri- or higher aliphatic alcohol include, but are not limited to, glycerin, trimethylol ethane, trimethylol propane, pentaerythritol, and sorbitol.

Specific examples of tri- or higher polyphenol include, but are not limited to, trisphenol PA, phenol novolac, and cresol novolac.

Specific examples of the adduct of polyphenols with tri- or higher alkylene oxide include, but are not limited to, an adduct of tri- or higher polyphenol with alkylene oxide such as ethylene oxide, propylene oxide, and butylene oxide.

It is preferable for the amorphous polyester resin A to include an aliphatic alcohol with a valence of at least three as a constituent component.

Inclusion of an aliphatic alcohol with a valence of at least three as a constituent component in the amorphous polyester resin A leads to a branched structure in the molecular skeleton, resulting in a three-dimensional network structure of molecular chains. This structure possesses rubber-like properties that allow itself to deform at low temperatures without flowing. Therefore, it becomes possible to maintain the high temperature storage stability and resistance to high-temperature offset of the toner.

The amorphous polyester resin A can also use trivalent or higher carboxylic acids or epoxies as cross-linking components. However, in the case of carboxylic acids, which are often aromatic compounds, the high density of ester bonds in the cross-linked sections may prevent the toner from achieving sufficient gloss in the fixed images formed by heat fixing. Cross-linking agents such as epoxies are used to conduct the cross-linking reaction after the polymerization of the polyester, which makes it difficult to control the distance between cross-linking points and potentially fails to achieve the desired viscoelasticity.

Furthermore, cross-linking agents may react with oligomers produced during polyesterization, thereby forming high-density cross-linked regions, which can lead to unevenness in the fixed images, resulting in poorer gloss and image density.

The trivalent or higher-valent carboxylic acid is not particularly limited and can be suitably selected according to a particular application. It includes a trivalent or higher-valent aromatic carboxylic acid. Their anhydrides, lower (1 to 3 carbon atoms) alkylester compounds, or halogenated compounds can be also used.

Tri- or higher aromatic carboxylic acid preferably has 9 to 20 carbon atoms. Specific examples of tri- or higher aromatic carboxylic acid having 9 to 20 carbon atoms include, but are not limited to, trimellitic acid and pyromellitic acid.

The polyisocyanate mentioned above is not particularly limited and can be suitably selected according to a particular application. Examples include, but are not limited to, diisocyanate and tri- or higher isocyanate.

Examples of the diisocyanates include, but are not limited to, aliphatic diisocyanates, alicyclic diisocyanates, aromatic diisocyanates, arylaliphatic diisocyanates, isocyanurates, and their blocked forms using a substance such as phenol derivatives, oximes, and caprolactam.

The aliphatic diisocyanate is not particularly limited and can be suitably selected according to a particular application.

Specific examples of the aliphatic di-isocyanates include, but are not limited to, tetramethylene diisocyanate, hexamethylene diisocyanate and 2,6-diisocyanate methylcaproate, octamethylene diisocyanate, decamethylene diisocyanate, dodecamethylene diisocyanate, tetradecamethylene diisocyanate, trimethyl hexane diisocyanate, and tetramethyl hexane diisocyanate.

The alicyclic diisocyanate is not particularly limited and can be suitably selected according to a particular application. Specific examples include, but are not limited to, isophorone diisocyanate and dicyclohexylmethane diisocyanate.

The aromatic diisocyanate is not particularly limited and can be suitably selected according to a particular application. Specific examples include, but are not limited to, tolylene diisocyanate, diphenylmethane diisocyanate, 1,5-naphthylene diisocyanate, 4,4-diisocyanate-3,3′-dimethyldiphenyl, 4,4′-diisocyanate-3-methyl diphenylmethane, and 4,4′-diisocyanate-diphenyl ether.

There is no specific limitation on the aromatic-aliphatic diisocyanates, and they can be chosen as needed for the purpose. One example is α, α, α′, α′-tetramethylxylylene diisocyanate.

Similarly, for isocyanurate compounds, there are no specific restrictions, and they can be chosen according to a particular application. Some examples include, but are not limited to, tris(isocyanatoalkyl) isocyanurates and tris(isocyanatocycloalkyl) isocyanurates.

These polyisocyanate can be used alone or in combination.

### Curing Agent

The curing agent is not particularly limited as long as it can react with the non-linear reactive precursor to produce the amorphous polyester resin A, and it can be appropriately selected according to the purpose. Examples include compounds containing active hydrogen groups.

The active hydrogen group in the compound containing an active hydrogen group is not particularly limited and may be appropriately selected according to a particular application. Specific examples include, but are not limited to, hydroxyl groups, such as alcoholic hydroxyl groups or phenolic hydroxyl groups, amino groups, carboxyl groups, and mercapto groups. These can be used alone or in combination.

The compound containing an active hydrogen group is not particularly limited and can be suitably selected according to a particular application. Amines are preferable to form urea bonds.

This amine is not particularly limited and can be suitably selected according to a particular application.

Specific examples include, but are not limited to, diamines, amines with three or more valences, amino alcohols, amino mercaptans, amino acids, and their blocked derivatives. Of these, dimine and a mixture of dimaine with a minute amount of polyamines having three or more amino groups are preferable. These can be used alone or in combination.

The diamines are not particularly limited and can be chosen as appropriate for the purpose, such as aromatic diamines, cycloaliphatic diamines, aliphatic diamines, and more.

There are no specific limitations on aromatic diamines, and they can be selected as appropriate for the purpose. Examples include, but are not limited to, phenylenediamines, diethyltoluenediamines, and 4,4′-diaminodiphenylmethane.

Similarly, there are no particular restrictions on cycloaliphatic diamines, and they can be selected based on the intended purpose. Some examples include, but are not limited to, 4,4′-diamino-3,3′-dimethyl-dicyclohexylmethane, diaminocyclohexane, and isophoronediamine.

For aliphatic diamines, there are no specific limitations, and they can be chosen according to the intended purpose. Some examples include, but are not limited to, ethylenediamine, tetramethylenediamine, and hexamethylenediamine.

As for the trivalent or higher amines, there are no specific restrictions, and they can be selected as needed for the purpose. Some examples include, but are not limited to, diethylenetriamine, triethylenetetramine,

The amino alcohols are not specifically restricted and can be chosen as needed for the purpose. Some examples include, but are not limited to, ethanolamine and hydroxyethyl aniline.

Similarly, the amino mercaptans are not specifically restricted and can be chosen according to a particular application. Some examples include, but are not limited to, aminoethyl mercaptan, and aminopropyl mercaptan.

The amino acids have no particular limit and can be suitably selected according to a particular application. For example, amino propionic acid and amino caproic acid are usable.

Similarly, for the blocked amino group, there are no specific restrictions, and they can be chosen as needed for the purpose.

Specific examples include, but are not limited to, ketimine compounds and oxazoline compounds prepared by blocking an amino group with a ketone such as acetone, methyl ethyl ketone, and methyl isobutyl ketone.

The amorphous polyester resin A preferably includes a diol component as a constituent, with the diol component containing at least 50 percent by mass of an aliphatic diol having 4 to 12 carbon atoms. Such amorphous polyester resin A is preferred because it can lower the glass transition temperature (Tg), thereby facilitating the toner to be deformable at low temperatures.

The amorphous polyester resin A preferably contains at least 50 percent by mass of an aliphatic diol having 4 to 12 carbon atoms among the total alcohol components. Such amorphous polyester resin A is preferred because it can lower the glass transition temperature (Tg), thereby facilitating the toner to be deformable at low temperatures.

The amorphous polyester resin A preferably includes a dicarboxylic acid component as a constituent, with the dicarboxylic acid component containing at least 50 percent by mass of an aliphatic dicarboxylic acid having 4 to 12 carbon atoms. Such amorphous polyester resin A is preferred because it can lower the glass transition temperature (Tg), thereby facilitating the toner to be deformable at low temperatures.

The weight average molecular weight of the amorphous polyester resin A is not particularly limited and can be suitably selected according to a particular application. It is preferably from 20,000 to 1,000,000, more preferably from 50,000 to 300,000, and furthermore preferably from 100,000 to 200,000 as measured by gel permeation chromatography (GPC).

The amorphous polyester resin A with a weight average molecular weight of at least 20,000 helps to solve problems such as the toner becoming too fluid at low temperatures, leading to poor high temperature storage stability, and decreased viscosity during melting, which in turn lowers the high-temperature offset resistance.

The molecular structure of the amorphous polyester resin A can be analyzed in solution or solid state using nuclear magnetic resonance (NMR), along with other methods such as X-ray diffraction, Gas Chromatography—Mass spectrometry (GC/MS), Liquid Chromatograph—Mass Spectrometry (LC/MS), and infrared (IR) absorption. A simple method of detecting an amorphous polyester resin involves identifying substances that exhibit absorption based on the δCH (out-of-plane vending vibration) of olefins at 965 cm⁻¹±10 cm⁻¹ or 990 cm⁻¹±10 cm⁻¹ in the infrared absorption spectrum as amorphous polyester resin A.

The proportion of the amorphous polyester resin A is not particularly limited and can be suitably selected according to a particular application. The number of parts of the amorphous polyester resin A is preferably from 5 to 25 parts by mass and more preferably from 10 to 20 parts by mass to 100 parts by mass of the toner mentioned above.

A content of at least 5 parts by mass of amorphous polyester resin A per 100 parts by mass of the toner is preferable, as it facilitates fixing at low temperatures and prevents offsetting at high temperatures.

A content of not more than 25 parts by mass of amorphous polyester resin A per 100 parts by mass of the toner is preferable for stable storage in a high-temperature environment and for obtaining images with better gloss after fixing.

Thus, having the content of the amorphous polyester resin A within the preferred range is advantageous, as it excels in the low-temperature fixability, high-temperature offset resistance, and high temperature storage stability.

### Amorphous Polyester Resin B

The amorphous polyester resin A is not particularly limited as long as its glass transition temperature (Tg) is 40 to 80 degrees Celsius, and can be suitably selected according to a particular application.

The amorphous polyester resin B is preferably a linear polyester resin.

Preferably, the amorphous polyester resin B is free of a urethane or urea bonding.

The amorphous polyester resin B is preferably an unmodified polyester resin.

The unmodified polyester resin is obtained using a polyol with a polycarboxylic acid including polycarboxylic anhydride, polycarboxylic acid ester, and their derivatives. It is not modified with a substance such as an isocyanate compound.

One such polyol is a diol.

Specific examples of diol includes, but are not limited to, an adduct of bisphenol A with alkylene (having two or three carbon atoms) oxide (average adduction mol number of from 1 to 10) such as polyoxypropylene(2,2)-2,2-bis(4-hydroxyphenyl)propane, polyoxyethylene(2,2)-2,2-bis(4-hydroxyphenyl)propane, ethylene glycol, propylene glycol, hydrogenated bisphenol A, and an adduct of hydrogenated bisphenol A with an alkylene (having two or three carbon atoms) oxide (average adduction mol number of from 1 to 10).

These can be used alone or in combination.

One specific example of the polycarboxylic acid is dicarboxylic acid.

Specific examples of the dicarboxylic acids include, but are not limited to, adipic acid, phthalic acid, isophthalic acid, terephthalic acid, fumaric acid, maleic acid, and succinic acid substituted with an alkyl group having 1 to 20 carbon atoms or alkenyl group having 2 to 20 carbon atoms such as dodecenyl succinic acid and octyl succinic acid.

These can be used alone or in combination.

The amorphous polyester resin B contains a dicarboxylic acid component, preferably containing terephthalic acid in an amount of at least 50 mol percent. Such amorphous polyester resins are advantageous for stable storage in a high temperature environment.

The amorphous polyester resin B mentioned above may optionally contain at least one of a tri- or higher carboxylic acid and a tri- or higher alcohol at the terminal of its resin chain to adjust the acid value and hydroxyl values.

Specific examples of tri- or higher carboxylic acid include, but are not limited to, trimellitic acid, pyromellitic acid, and their anhydrides.

Specific examples of tri- or higher alcohol include, but are not limited to, glycerin, pentaerythritol, and trimethylol propane.

The molecular weight of the amorphous polyester resin B is not particularly limited and can be appropriately selected according to the purpose. In gel permeation chromatography (GPC) measurements, the weight average molecular weight (Mw) is preferably 3,000 to 10,000 and more preferably 4,000 to 7,000, the number average molecular weight Mn is preferably 1,000 to 4,000 and more preferably 1,500 to 3,000, and the Mw/Mn ratio is preferably 1.0 to 4.0 and more preferably 1.0 to 3.5.

If the molecular weight of the amorphous polyester resin B is too low, the toner may have poor high temperature storage stability and durability against stresses such as agitation in the developing machine. Conversely, if the molecular weight is too high, the toner may have high viscoelasticity during melting, leading to poor low-temperature fixability. Within the above preferable ranges, these issues can be resolved, which is suitable.

The acid value of the amorphous polyester resin B has no particular limit and can be suitably selected according to a particular application. A range of 1 to 50 mg KOH/g is preferable, with 5 to 30 mg KOH/g being even more favorable.

An acid value of at least 1 mgKOH/g tends to negatively charge a toner and enhances the affinity between a recording medium such as paper and the toner during fixing on the recording medium, enhancing the low temperature fixability.

An acid value of the amorphous polyester resin B of not greater than 50 mg KOH/g enhances the charge stability, particularly the charge stability against environmental changes.

The hydroxyl value of the amorphous polyester resin B is not particularly limited and can be suitably selected according to a particular application. The value is preferably at least 5 mgKOH/g.

The glass transition temperature Tg of the amorphous polyester resin B is preferably from 40 to 80 degrees Celsius and more preferably from 50 to 70 degrees Celsius.

A glass transition temperature of the amorphous polyester resin B of at least 40 degrees Celsius enhances the toner's high temperature storage stability and its durability to stress such as stirring in a developing device while enhancing the resistance to filming.

A glass transition temperature of the amorphous polyester resin B of at least 80 degrees Celsius suitably transforms the shape of toner with heat and pressure in fixing, thereby enhancing the low temperature fixability.

The method of measuring the glass transition temperature of the amorphous polyester resin A and the amorphous polyester resin B is not particularly limited and can be suitably selected according to a particular application. For example, it can be measured with a differential scanning calorimeter (Q-200, available from TA Instruments). A specific measuring method is as follows.

### Example of Measurement Method for Glass Transition Temperature Tg

About 5.0 mg of a target sample is put in an aluminum sample container, which is then placed on a holder unit. The unit and the container are sequentially disposed in an electric furnace. Next, under a nitrogen atmosphere, the temperature is raised from −80 to 150 degrees Celsius at a temperature rising rate of 10 degrees Celsius per minute. The glass transition temperature (Tg) of the sample is then determined using the analysis program installed in the differential scanning calorimeter (DSC) from the obtained DSC curve.

The molecular structure of the amorphous polyester resin B can be analyzed in solution or solid state using nuclear magnetic resonance (NMR), along with other methods such as X-ray diffraction, Gas Chromatography—Mass spectrometry (GC/MS), Liquid Chromatograph—Mass Spectrometry (LC/MS), and infrared (IR) absorption. A simple method of detecting an amorphous polyester resin involves identifying substances that exhibit absorption based on the δCH (out-of-plane vending vibration) of olefins at 965 cm⁻¹±10 cm⁻¹ or 990 cm⁻¹±10 cm⁻¹ in the infrared absorption spectrum as amorphous polyester resin.

The proportion of the amorphous polyester resin B is not particularly limited and can be suitably selected according to a particular application. The number of parts of the amorphous polyester resin A is preferably from 50 to 90 parts by mass and more preferably from 60 to 80 parts by mass to 100 parts by mass of the toner mentioned above.

A content of the amorphous polyester resin B of at least 50 parts by mass per 100 parts by mass of the toner enhances the dispersibility of the pigment and the release agent in the toner, making it possible to reduce the occurrence of image fogging and disturbances, which is preferable.

When the content of the amorphous polyester resin B is 90 parts by mass or more per 100 parts by mass of the toner, the content of the crystalline polyester resin C and the amorphous polyester resin A becomes appropriate, resulting in good low-temperature fixability, which is preferable.

When the content of the amorphous polyester resin B is between 60 parts by mass and 80 parts by mass per 100 parts by mass of the toner, it is advantageous as it excels in both high image quality and low-temperature fixability.

It is preferable to use the amorphous polyester resin A in combination with the crystalline polyester resin for fixing at low temperatures.

To strike a balance between the low temperature fixability and high-temperature high-humidity storage stability, it is preferable that the amorphous polyester resin A have a low glass transition temperature. The amorphous polyester resin A with a low glass transition temperature deforms under heat and pressure during fixing, making it easier to adhere to recording media such as paper at lower temperatures, which is preferable.

### Acid Value of Toner

The acid value of the toner of the present disclosure is preferably from 6 to 12 mgKOH/g. During fixing, the acidic groups in the polyester resin and the aromatic petroleum resin described later exhibit moderate affinity, allowing the aromatic petroleum resin to be present at the interface between the binder resin and the release agent particle domains.

When the acid value exceeds 12 mgKOH/g, the aromatic petroleum resin becomes compatible, making the release agent particles more likely to be present independently, which may result in inferior photoconductor filming. When the acid value falls below 6 mgKOH/g, the affinity of the aromatic petroleum resin decreases, making the release agent particles more likely to exist independently, which may also result in inferior photoreceptor filming.

The acid value of the toner is measured according to the method described in JIS K0070-1992 (Test methods for acid value, saponification value, ester value, iodine value, hydroxyl value and unsaponifiable matter of chemical products) under the following condition:

Sample preparation: Add and dissolve 0.5 g of the toner to 120 ml of toluene by stirring at room temperature (23 degrees Celsius) for about 10 hours; and add 30 ml of ethanol to prepare a sample solution.

This measurement is calculated by the measuring device specified above.

Specific calculation is as follows: Titration is conducted using preliminarily set alcohol solution of N/10 potassium hydroxide and the acid value is obtained by the following relation based on the consumption amount of the alcohol solution of potassium:

$$Acid value : KOH ( mL number ) \times N \times 56.1 / sample mass ( N represents a factor of N / 10 KOH )$$

Specifically, the acid value of the toner is determined in the following procedure:
Measuring device: automatic potentiometric titrator DL-53 Titrator, manufactured by Mettler Toledo International Inc.
Electrode: DG113-SC, manufactured by Mettler Toledo International Inc.
Analyzing software: LabX Light Version 1.00.000
Calibration of device: Using a liquid solvent of 120 ml of toluene and 30 ml of ethanol
   Measuring temperature: 23 degrees Celsius
The measuring conditions are as follows.
Stirring condition
Stirring speed (percent): 25
Stirring time (s): 15
Equilibrium titration condition:
   Titration liquid: CH₃ONa
   Concentration (mol/L): 0.1
   Electrode: DG 115
   Measuring unit: mV
   Titration of volumetric solution prior to measuring
   Titer (mL): 1.0
   Waiting time (s): 0
   Titration mode of volumetric solution: Dynamic
   dE (set) [mV]: 8.0
   dV (min) [mL]: 0.03
   dV (max) [mL]: 0.5
Measuring mode: equilibrium titration
   dE [mV]: 0.5
   dt [s]: 1.0
   t (min) [s]: 2.0
   t (max) [s]: 20.0
Recognition condition
   Threshold: 100.0
   Only maximum change rate: No
   Range: No
   Frequency: None
Measuring complete condition:
   Maximum titer (mL): 10.0
   Voltage: No
   Gradient: No
   After equivalent point: Yes
   n number: 1
   Combination of complete conditions: No
Evaluation condition
   Procedure: Standard
   Voltage 1: No
   Voltage 2: No
   Stop for re-evaluation: No

### Hydroxyl Value of Toner

The hydroxyl value of the toner of the present disclosure is preferably from 25 to 45 mgKOH/g. More preferably, it is from 30 to 40 mgKOH/g. When the hydroxyl value is higher than 45 mg KOH/g, moisture is adsorbed under high-temperature and high-humidity conditions, causing a decrease in charge amount, which leads to abnormal images such as background fouling and toner scattering. When the hydroxyl value is lower than 25 mg KOH/g, the fixing performance between the resin and paper deteriorates, resulting in reduced low-temperature fixability and offset resistance.

The measurement of the hydroxyl value of the toner is performed in accordance with the method described in JIS K0070-1992 (Test methods for acid value, saponification value, ester value, iodine value, hydroxyl value and unsaponifiable matter of chemical products) under the following conditions:

### Sample Preparation:

(1) Preparation of 0.5 mol/L Potassium Hydroxide Titration Solution

A 0.5 mol/L potassium hydroxide titration solution is prepared by dissolving 40 g of potassium hydroxide in 50 mL of ion-exchanged water. After discarding 10 mL of the supernatant of the prepared potassium hydroxide solution, methanol is added to make a total volume of 1000 mL.

### (2) Preparation of Liquid Mixture of Methanol and Acetone

A liquid mixture of methanol and acetone is prepared by mixing 1 L of methanol and 1 L of acetone, adding one drop of BTB reagent and 30 mL of PP indicator, and then adding 0.1 mol/L potassium hydroxide methanol solution until a faint reddish-purple color appears.

(3) Five g of toner is accurately weighed into a conical flask, 5 mL of a liquid mixture of acetic anhydride/pyridine (1:4) is added using a volumetric pipette, and 25 mL of pyridine is added using a graduated cylinder. A reflux condenser is attached, and the mixture is reacted in an oil bath at 98 degrees Celsius for 1.5 hours.
(4) Three mL of deionized water is added from the top of the condenser, followed by heating in the oil bath for an additional 10 minutes.
(5) The conical flask is removed from the oil bath and cooled to room temperature. The condenser is washed with acetone and then removed.
(6) Fifty mL of tetrahydrofuran is added using a graduated cylinder, and 10 drops of PP indicator are added. Titration is performed using the 0.5 mol/L potassium hydroxide titration solution prepared in step (1). Near the endpoint, 25 mL of the liquid mixture of methanol and acetone prepared in step (2) is added, and titration is continued. The endpoint is defined as the point where a faint red color persists for 30 seconds to determine the titration volume.
(7) The operations in steps (3) to (6) are performed without the sample as a blank test.
(8) The hydroxyl value is calculated using the following formula:

$$Hydroxyl value = [ ( B - A ) \times f \times 28.05 / S ] + Acid value ,$$

A: Titration volume of 0.5 mol/L potassium hydroxide solution required for the main test
B: Titration volume of 0.5 mol/L potassium hydroxide solution required for the blank test
f: Factor of the 0.5 mol/L potassium hydroxide titration solution
S: Sample weight (g)

### Release Agent

The release agent for use in the present disclosure is not particularly limited and can be suitably selected according to a particular application.

Specific examples of such waxes include, but are not limited to, natural waxes including: vegetable waxes such as carnauba wax, cotton wax, Japan wax, and rice wax; animal waxes such as bee wax and lanolin; mineral waxes such as ozokerite; and petroleum waxes such as paraffin, microcrystalline, and petrolatum.

In addition to these natural waxes, synthesis hydrocarbon waxes such as Fischer-Tropsch wax, polyethylene wax, and polypropylene and synthesis wax such as ester, ketone, and ether are also usable.

Furthermore, fatty acid amide compounds such as 12-hydroxystearic acid amide, stearic acid amide, phthalic anhydride imide, and chlorinated hydrocarbons; homopolymers or copolymers of polyacrylates, such as poly-n-stearyl methacrylate and poly-n-lauryl methacrylate (for example, a copolymer of n-stearyl acrylate and ethyl methacrylate), which are crystalline polymer resins with a low molecular weight; and crystalline polymers with a long alkyl group in the side chain can also be used.

Of these, hydrocarbon waxes such as paraffin wax, microcrystalline wax, Fischer-Tropsch wax, polyethylene wax, and polypropylene wax are preferable to reduce the occurrence of filming.

Hydrocarbon waxes have limited compatibility with common polyester resins, causing them to migrate to the surface during fixing. This migration enhances releasability, resulting in improved gloss and excellent low-temperature fixability. There is no specific limitation on the melting point of the release agent for use in the present disclosure. The melting point is preferably from 80 to 100 degrees Celsius. A melting point of at least 80 degrees Celsius ensures high temperature stability and a melting point of at most 100 degrees Celsius provides adequate low temperature fixability.

There is no particular limitation on the content of the release agent in the toner of the present disclosure, and it can be appropriately selected according to a particular application. A content of 2 to 6 parts by mass is preferable, and 3 to 5 parts by mass is more preferable based on a total of 100 parts by mass of the binder resin, the release agent, and the aromatic petroleum resin contained in the toner. When the content of the release agent is at least 2 parts by mass based on a total of 100 parts by mass of the binder resin, the release agent, and the aromatic petroleum resin contained in the toner, sufficient bleeding to the surface during fixing is achieved, resulting in good releasability, and low-temperature fixability and high-temperature offset resistance are ensured.

When the content is at most 6 parts by mass, the amount of release agent precipitated on the toner surface does not become excessive, thereby ensuring storage stability and flowability of the toner, preventing deterioration in anti-filming on an electrostatic latent image bearer, and maintaining the conveyability of residual toner after transfer.

### Aromatic Petroleum Resin

There is no particular limitation on the aromatic petroleum resin for use in the toner of the present disclosure, and it can be appropriately selected according to a particular application. From the viewpoint of balancing compatibility and incompatibility with polyester resin, styrene-based resin is preferable.

Specific examples of styrene resins include, but are not limited to, polymers of styrene and its derivatives, such as polystyrene, poly-p-styrene, polyvinyltoluene, styrene-α-methylstyrene copolymer, styrene-p-chlorostyrene copolymer, styrene-propylene copolymer, styrene-vinyltoluene copolymer, styrene-methyl acrylate copolymer, styrene-ethyl acrylate copolymer, styrene-butyl acrylate copolymer, styrene-methyl methacrylate copolymer, styrene-ethyl methacrylate copolymer, styrene-butyl methacrylate copolymer, styrene-α-chloro methyl methacrylate copolymer, styrene-acrylonitrile copolymer, styrene-vinyl methyl ether copolymer, styrene-vinyl methyl ketone copolymer, styrene-butadiene copolymer, styrene-isoprene copolymer, styrene-maleic acid copolymer, and styrene-maleic acid ester copolymer.

### Glass Transition Temperature (Tg) of Aromatic Petroleum Resin

In the present disclosure, the glass transition temperature (Tg) of the aromatic petroleum resin used is preferably 70 to 90 degrees Celsius, more preferably 75 to 90 degrees Celsius, and even more preferably 80 to 90 degrees Celsius. A glass transition temperature of at least 70 degrees ensures heat storage stability of the toner and a glass transition temperature of at most 90 degrees Celsius provides adequate low-temperature fixing performance.

The glass transition temperature (Tg) in the present disclosure is measurable, for example, using a differential scanning calorimeter (DSC210, manufactured by Seiko Instruments Inc.). Specifically, for example, using a differential scanning calorimeter (DSC210, manufactured by Seiko Instruments Inc.), a sample of 0.01 to 0.02 g is weighed into an aluminum pan and heated up to 150 degrees Celsius. From that temperature, the sample is cooled to 20 degrees Celsius at a cooling rate of 10 degrees Celsius/minute, and then reheated at a heating rate of 10 degrees Celsius/minute. The glass transition temperature (Tg) is defined as the intersection point between the extension of the baseline below the highest endothermic peak and the tangent showing the maximum slope from the rising portion of the peak to its apex.

There is no particular limitation on the content of the aromatic petroleum resin in the toner of the present disclosure, and it can be appropriately selected according to a particular application. The content of the aromatic petroleum resin is preferably 7 to 9.5 parts by mass and more preferably from 7 to 8 parts by mass, relative to a total content of 100 parts by mass of the binder resin, release agent, and aromatic petroleum resin contained in the toner. A content of at least 7 parts by mass relative to a total content of 100 parts by mass of the binder resin, release agent, and aromatic petroleum resin contained in the toner suppresses a decrease in grindability during pulverization of the kneaded toner material and ensure productivity of the pulverized product, while a content of at most 9.5 parts by mass ensures low-temperature fixing performance of the resulting toner.

### Colorant

Specific examples of the colorant include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and mixtures thereof. The content of a colorant is from 0.1 to 80 parts by weight relative to 100 parts by mass of a binder resin in general.

The toner of the present disclosure preferably has an average circularity of 0.93 to 0.96.

### External Additive

Examples of such external additives are, for example, abrasives such as silica, Teflon® resin powder, polyvinylidene fluoride powder, cerium oxide powder, silicon carbide powder, and strontium titanate powder, flow improvers such as titanium oxide powder, and aluminum oxide powder, agglomeration inhibitors, resin powder, and conductivity imparting agents such as zinc oxide powder, antimony oxide powder, and tin oxide powder. In addition, white particulates and black particulates having reverse polarity can be used as development improvers. These can be used alone or in combination. These are added to be against development stress such as idling.

### Developing Agent

In the case of using a two-component developing agent, specific examples of magnetic fine particles for use in the magnetic carrier include, but are not limited to, spinel ferrites such as magnetite and gamma ferric oxide, spinel ferrites containing one or two types of metals such as Mn, Ni, Zn, Mg, and Cu other than iron, magnetoplumbite type ferrites such as barium ferrite, and iron or alloyed metal particles with an oxidized layer on the surface. The magnetic carrier may have any form, such as a particulate form, a spherical form, or a needle-like form. In particular, it is preferable to use ferromagnetic fine particles, such as iron, to achieve strong magnetization. In addition, in terms of chemical stability, it is preferable to use spinel ferrite such as magnetite and gamma ferric oxide and magnetoplumbite type ferrite such as barium ferrite. A resin carrier with a desired magnetization can be used depending on the type and content of ferromagnetic fine particles. The carrier preferably has a magnetization of 30 to 150 emu/g at 1,000 Oersted.

Such resin carriers can be manufactured by spraying, using a spray dryer, a melt-kneaded mixture of magnetic fine particles and an insulating binder resin. It is also possible to produce resin carriers in which magnetic fine particles are dispersed in a condensation-type binder formed by reacting and curing monomers or prepolymers in an aqueous medium in the presence of magnetic fine particles.

The magnetic carrier can be coated with resin or have positively or negatively charged fine particles or electroconductive fine particles fixated on the surface of the magnetized carrier to control the chargeability.

As a coating material for the surface of the magnetic carrier, silicone resin, acrylic resin, epoxy resin, and fluororesin are usable, with silicone resin and acrylic resin being preferred. The surface of the magnetic carrier can be coated with these resins or with resins further containing positively or negatively chargeable fine particles or conductive fine particles as the coating material.

The mixing ratio of the toner of the present disclosure and magnetized carriers is preferably from 2 to 10 percent by mass as toner concentration.

The weight average molecular weight of the toner is preferably from 2 to 10 m.

The particle size of the toner is measured by various methods. For example, using a Coulter Counter Multisizer III, a measurement sample is prepared by adding the toner to an electrolytic solution containing a surfactant and dispersing it for one minute with an ultrasonic disperser, and the dispersed sample is then used to measure 50,000 particles.

To produce the electrostatic image-developing toner of the present disclosure, a fixing resin in which a lubricant, and optionally a colorant, and further optionally a charge control agent, lubricant, and additives are uniformly dispersed is combined and thoroughly mixed using a mixer such as a Henschel mixer or a super mixer. The mixture is then melt-kneaded using a thermal melt-kneading machine such as heated rolls, a kneader, or an extruder to sufficiently mix the materials. After cooling and solidification, the mixture is finely pulverized and classified to obtain the toner. As the pulverization method, it is possible to employ a jet mill method of adding toner to a jet air followed by collision with a collision board to pulverize the toner using its collision energy, an interparticle collision method of colliding toner particles in an air stream, or a mechanical pulverization method of supplying toner into a narrow gap with a rotor rotating at high speed.

### Image Forming Apparatus and Image Forming Method

The image forming apparatus of the present disclosure preferably includes an electrostatic latent image bearer, an electrostatic latent image forming device for forming an electrostatic latent image on the electrostatic latent image bearer, a developing device for developing the electrostatic latent image on the electrostatic latent image bearer with the toner of the present invention to form a toner image, a transfer device for transferring the toner image onto the surface of a printing medium, and a fixing device for fixing the toner image on the surface of the printing medium. It optionally includes other devices such as a discharging (quenching) device, a cleaning device, a recycling device, and a control device.

The image forming method of the present invention preferably includes forming an electrostatic latent image on an electrostatic latent image bearer, developing the electrostatic latent image formed on the electrostatic latent image bearer with the toner of the present invention to form a toner image, transferring the toner image formed on the electrostatic latent image bearer to the surface of a printing medium, and fixing the toner image transferred to the surface of the printing medium. It may optionally include processes such as discharging (quenching), cleaning, recycling, and controlling.

### Electrostatic Latent Image Forming Step and Electrostatic Latent Image Forming Device

In the forming an electrostatic latent image, an electrostatic latent image is formed on an electrostatic latent image bearer.

The electrostatic latent image forming device forms an electrostatic latent image on the electrostatic latent image bearer.

The electrostatic latent image forming process can be suitably executed by the electrostatic latent image device.

There is no specific limitation to the electrostatic latent image bearer (also referred to as electrophotographic photoconductor, photoconductor, or photoreceptor) with regard to material, form, structure, size, etc. And any known electrostatic latent image bearer can be suitably selected. An electrostatic latent image bearer having a drum-like form is preferable. Also, for example, an inorganic photoconductor made of amorphous silicone or selenium and an organic photoconductor (OPC) made of polysilane or phthalopolymethine are suitable.

One example of the organic photoconductor is a layered photoconductor, including layers—a charge-generation layer formed of a non-metallic material like phthalocyanine, or titanyl phthalocyanine dispersed in a binder resin and a charge-transport layer formed of a charge transport material dispersed in a binder resin-stacked on a substrate such as an aluminum drum.

Another type is a single-layer photoconductor with a single-layer structure on a substrate, featuring a photosensitive layer formed of both charge-generation and a charge-transport material dispersed in a binder resin.

In the single-layer photoconductor, hole transport agents and electron transport agents can be added to the photosensitive layer as charge transport materials.

Additionally, an undercoat layer may be provided between the substrate and either the charge generation layer of a multi-layer photoconductor or the photosensitive layer of a single-layer photoconductor.

Electrostatic latent images are formed by, for example, uniformly charging the surface of the electrostatic latent image bearer and irradiating the surface according to the obtained image information.

The electrostatic latent image forming device preferably includes at least a charger serving as a charging device for uniformly charging the surface of the electrostatic latent image bearer and an irradiator serving as an irradiating device for irradiating the surface of the electrostatic latent image bearer with light according to the obtained image information.

Charging is carried out, for instance, by applying a bias to the surface of the image bearer using the charging device.

The charging device (charger) is not particularly limited and can be suitably selected according to a particular application. Specific examples include, but are not limited to, a known contact type charger that includes an electroconductive or semiconductive roll, brush, film, or a rubber blade, and a non-contact type charger using corona discharging such as corotron and scorotron.

Preferably, the charger is disposed in contact or non-contact with the electrostatic latent image bearer and applies a direct voltage and an alternating voltage superimposed thereon to the surface of the electrostatic latent image bearer. The charger is preferably a charging roller disposed in contact with the electrostatic latent image bearer with a gap tape therebetween. It is preferable that the charging roller apply a direct voltage on which an alternate voltage is superimposed to charge the surface of the electrostatic latent image bearer.

The irradiation is conducted by, for example, irradiating the surface of the electrostatic latent image bearer with the irradiator.

The irradiator is not particularly limited and it can be suitably selected according to a particular application as long as it can irradiate imagewise the surface of the electrostatic latent image bearer charged by the charger.

Specific examples of such irradiators include, but are not limited to, a photocopying optical system, a rod lens array system, a laser optical system, and a liquid crystal shutter optical system.

In the present disclosure, a dorsal irradiation system can be employed, where the electrostatic latent image bearer is irradiated from the rear side in an imagewise manner.

### Developing Process and Developing Device

In the developing process, electrostatic latent images formed on the electrostatic latent image bearer are developed with the toner to form toner images.

The developing unit develops electrostatic latent images formed on the electrostatic latent image bearer with the toner to form toner images.

The printing process can be suitably conducted by the printing device.

The toner image can be formed by, for example, developing the electrostatic latent image with the toner.

The developing device preferably includes a developing unit for accommodating toner and supplying it to the electrostatic latent image in either a contact or non-contact manner. The developing unit preferably includes a toner container.

The developing unit is either a single color developing unit or a multi-color developing unit. The developing unit suitably includes, for example, a stirrer to triboelectrically charge the toner and a rotatable magnet roller.

### Transfer Process and Transfer Device

In the transfer process, the toner image formed on the electrostatic latent image bearer is transferred onto the surface of a recording medium.

The transfer device transfers the toner image formed on the electrostatic latent image bearer onto the surface of a recording medium.

The transfer process can be suitably conducted by the corresponding transfer device.

In the transfer process mentioned above, the visible image mentioned above is transferred to a printing medium. Preferably, the toner image is primarily transferred to an intermediate transfer member and thereafter secondarily transferred to the printing medium. It is more preferable that, with a two-color toner, preferably a full color toner, the toner image is primarily transferred to the intermediate transfer member to form a complex transfer image and the complex transfer image is thereafter secondarily transferred to the printing medium.

The transfer device (the primary transfer device and the secondary transfer device mentioned above) preferably includes a transfer unit for peeling-charge the toner image formed on the electrostatic latent image bearer or photoconductor to peel the image to the printing medium. One or more transfer devices can be provided. Specific examples of the transfer device include, but are not limited to, a corona transfer device using corona discharging, a transfer belt, a transfer belt, a transfer roller, a pressure transfer roller and an adhesive transfer device.

There is no specific limitation on the recording medium and any known recording medium (typically paper) can be suitably used.

### Fixing Process and Fixing Device

In the fixing process, the toner image transferred to the surface of a recording medium is fixed thereon.

The fixing device fixes the toner image transferred to the surface of the recording medium.

The recycling process can be suitably conducted by a corresponding recycling device.

The fixing process can be executed every time each color toner image is transferred to a recording medium. Alternatively, the fixing process can be conducted for a multi-color superimposed toner image.

There is no specific limitation on the fixing device and it can be suitably selected according to a particular application. Using a known device that applies heating and pressure is preferable. The heating and pressing device includes, but is not limited to, a combination of a heating roller and a pressing roller or a combination of a heating roller, a pressing roller, and an endless belt can be suitably used.

### Discharging Process and Discharging Device

In the discharging process (charge removal process, quenching process), a discharging bias (a charge removal bias) is applied to the electrostatic latent image bearer to remove the charge thereon.

The discharging device (charge removal device, quenching device) is to remove the charge on the electrostatic latent image bearer by applying a charge removal bias thereto.

The discharging process can be suitably conducted by a corresponding discharging device.

The discharging device is not particularly limited as long as it can apply a discharging bias to the electrostatic latent image bearer. It can be selected among the known discharging devices. One such device is a discharging lamp.

### Cleaning Process and Cleaning Device

In the cleaning process, toner remaining on the surface of the electrostatic latent image bearer is removed.

The cleaning device is to remove the toner remaining on the surface of the electrostatic latent image bearer.

The cleaning process can be suitably conducted by a corresponding cleaning device.

As the cleaning device, any known cleaner that can remove the toner remaining on the surface of the electrostatic latent image bearer is suitable. For example, a magnetic brush cleaner, an electrostatic brush cleaner, a magnetic roller cleaner, a blade cleaner, a brush cleaner, and a web cleaner are preferable.

### Recycling Process and Recycling Device

In the recycling process, the toner removed in the cleaning process mentioned above is returned to the developing device for re-use.

The recycling device is to return the toner removed by the cleaning device mentioned above to the developing device for re-use. There is no specific limitation on the recycling device and any devices including known conveying device can be used.

The recycling process can be suitably conducted by a corresponding recycling device.

### Control Process and Control Device

In the control process, each of the processes described above is controlled.

The control device controls each of the aforementioned devices.

The control process can be suitably conducted by a corresponding controlling device.

The control device (controller) is not particularly limited and can be suitably selected according to a particular application as long as it can control the behavior of each device. Specific examples include, but are not limited to, a sequencer and a computer.

### Method of Producing Printed Material

The method of producing a printed material (printed matter) of the present disclosure preferably forms a printed material on recording media using an electrostatic latent image bearer, an electrostatic latent image forming device for forming an electrostatic latent image on the electrostatic latent image bearer, a developing device for developing the electrostatic latent image on the electrostatic latent image bearer with toner to form a toner image, a transfer device for transferring the toner image onto the surface of a recording medium, and a fixing device for fixing the toner image on the surface of the recording medium. The method may optionally include other optional processes.

The printed matter mentioned above includes a recording medium and an image formed on the recording medium with the toner of the present invention.

Since each process in the method of producing printed matter can use the same techniques as the aforementioned image forming method, redundant explanations are omitted.

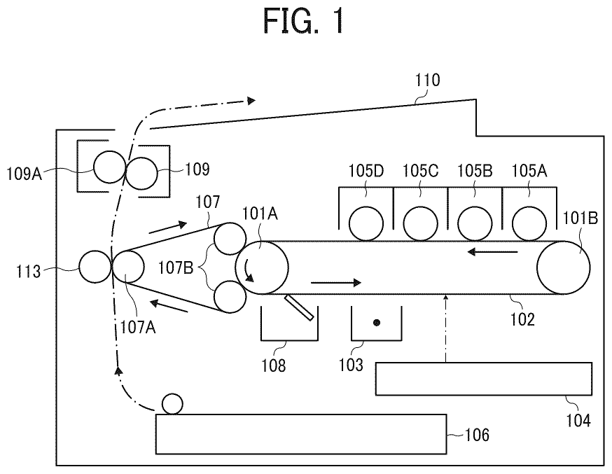

FIG. 1 is a diagram illustrating an example of the electrophotographic imaging device (image forming apparatus).

In FIG. 1, the image forming apparatus includes a drive roller 101A, a driven roller 101B, a photoconductor belt 102, a charger 103, a laser writing(drawing) unit 104, each of developing units 105A, 105B, 105C, and 105D to accommodate each color toner of yellow, magenta, cyan, and black, a sheet feed cassette 106, an intermediate transfer belt 107, a drive shaft roller 107A to drive the intermediate transfer belt 107, a driven shaft roller to support the intermediate transfer belt 107, a cleaning device 108, a fixing roller 109, a pressure roller 109A, an ejection tray 110, and a sheet transfer roller 113.

In this color image forming apparatus, the intermediate transfer belt 107 is flexible for a transfer drum. The intermediate transfer belt 107 serving as the intermediate transfer body is circularly conveyed clockwise while being stretched over the drive shaft roller 107A and a pair of the driven shaft rollers 107B. The belt surface between the pair of the driven shaft rollers 107B is brought into contact with the photoconductor belt 102 at the outer circumference of the drive roller 101A.

During normal color image output, each color toner image formed on the photoconductor belt 102 is transferred to the intermediate transfer belt 107 each time it is formed, thereby combining the color toner images. The combined toner image is then collectively transferred onto a transfer sheet, which is conveyed from the sheet feed cassette 106, by the sheet transfer roller 113. After the transfer, the transfer sheet is conveyed to the space between the fixing roller 109 and the pressure roller 109A of the fixing device, and after being fixed by the fixing roller 109 and the pressure roller 109A, the paper is discharged to the ejection tray 110.

When the developing units 105A to 105E develop the latent image with toner, the toner concentration of the developing agent contained in the developing units decreases. The decrease in toner concentration of the developing agent is detected by a toner concentration sensor. When a decrease in toner concentration is detected, a toner replenishing device connected to each developing unit operates to replenish toner and increase the toner concentration. At this time, the replenished toner may be a developing agent for a so-called trickle development method, in which carrier and toner are mixed, provided that the developing unit is equipped with a developing agent ejection mechanism.

In FIG. 1, the toner images of respective colors are superimposed on the intermediate transfer belt to form a color toner image. Also, the image forming apparatus of the present disclosure includes a configuration in which the toner images are directly transferred from a transfer drum to a recording medium without using an intermediate transfer belt.

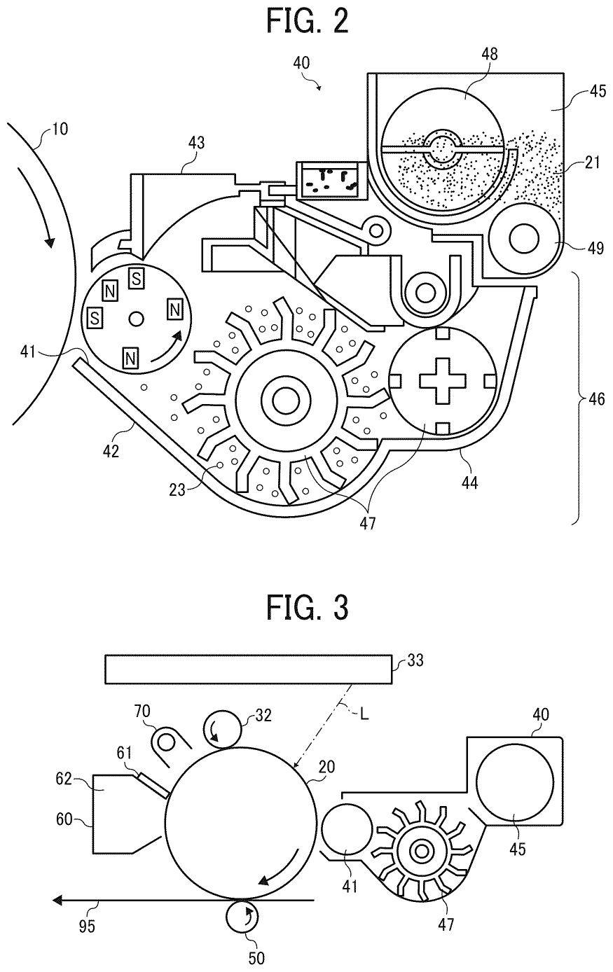

FIG. 2 is a schematic diagram illustrating an example of the developing device for use in the present disclosure and the following variations are within the scope of the present disclosure.

A developing device 40 illustrated in FIG. 2 is disposed facing the photoconductor 10 serving as an electrostatic latent image bearer. The developing device 40 includes a development sleeve 41 serving as a developing agent bearer, a developing agent accommodating member 42, a doctor blade 43 serving as a regulating member, a supporting housing 44, etc.

To the supporting housing 44 having an aperture on the side of the photoconductor 10, a toner hopper 45 serving as a toner accommodating unit to accommodate a toner 21 inside is ensured. A developing agent accommodating unit 46 accommodating a developing agent including the toner 21 and a carrier 23 is disposed adjacent to the toner hopper 45. The developing agent accommodating unit 46 includes a developing agent stirring mechanism 47 to stir the toner 21 and the carrier 23 to triboelectrically charge and peeling-charge the toner 21.

Inside the toner hopper 45, a toner agitator 48, which serves as a toner supplying device rotationally driven by a drive device, and a toner replenishment mechanism 49 are provided. The toner agitator 48 and the toner replenishment mechanism 49 send out the toner 21 in the toner hopper 45 towards the developing agent accommodating unit 46.

The development sleeve 41 is disposed at the space between the photoconductor 10 and the toner hopper 45. The development sleeve 41 rotationally driven by the drive device in the direction indicated by an arrow includes a magnet inside serving as a magnetic field generating device. The magnet is disposed and fixed relatively to the developing device 40 to form a magnetic brush of the carrier 23.

The doctor blade 43 is integrally mounted with the developing agent accommodating member 42 on the other side of the supporting housing 44, facing the developing agent accommodating member 42. In this example, the doctor blade 43 is disposed with a constant gap between the front end of the doctor blade 43 and the outer periphery of the development sleeve 41.

Using such a device in a non-limiting manner, the image forming method of the present disclosure is carried out as follows.

That is, by the above configuration, the toner 21 delivered from inside the toner hopper 45 by the toner agitator 48 and the toner replenishment mechanism 49 is conveyed to the developing agent accommodating unit 46, where it is agitated by the developing agent stirring mechanism 47 so that a desired friction and separation charge is imparted. Together with the carrier 23, the toner functions as a developing agent, is carried on the development sleeve 41, and transferred to a position facing the outer peripheral surface of the photoconductor 10. There, only the toner 21 electrostatically couples with the electrostatic latent image formed on the photoconductor 10, thereby forming a toner image on the photoconductor 10.

FIG. 3 is a diagram illustrating an example of the image forming apparatus including the developing device illustrated in FIG. 2 Around the drum-shaped photoconductor 10, a charging member 32, an image irradiating system 33, the developing device 40, a transfer device 50, a cleaning device 60, and a discharge lamp 70 are arranged. In this example, the surface of the charging member 32 is in a non-contact state with a gap of about 0.2 mm from the surface of the photoconductor 10. When charging the photoconductor 10 by the charging member 32, the photoconductor 10 is charged by an electric field in which an AC component is superimposed on a DC component by a voltage applying device to the charging member 32, thereby making it possible and effective to reduce uneven charging. The image forming method, including the developing method, is performed by the following operations.

A series of the image forming processes are described using a negative-positive process. The photoconductor 10 represented by an organic photoconductor (OPC) including an organic photoconductive layer is discharged by the discharging lamp 70, uniformly and negatively charged by the charging member 32 such as a charger and a charging roller, irradiated with a laser beam emitted from the image irradiating system 33 of a laser optical system, etc. To form an electrostatic latent image (the absolute value of the irradiated site voltage is lower than the absolute value of the non-irradiated site voltage in this example).

The laser beam is emitted from, for example, a semiconductor laser and scans the surface of the photoconductor 10 in the rotation axis direction of the photoconductor 10 by, for example, the light reflected at a polygon mirror having a polygonal column rotating at a high speed. The thus-formed electrostatic latent image is developed by a mixture of toner and carrier supplied onto the development sleeve 41 serving as a developing agent bearer included in the developing device 40 to form a toner image. During development of the latent image, a developing bias of a DC voltage of an appropriate magnitude or a DC voltage superimposed with an AC voltage is applied to the development sleeve 41 from a voltage applying mechanism, between the exposed and unexposed areas of the photoconductor 10.

A transfer medium (typically, paper) 95 is fed from a sheet feeding mechanism between the photoconductor 10 and the transfer device 50 in synchronization with the front end of the image at a pair of registration rollers to transfer the toner image. It is preferable that a voltage having a polarity reversed to that of the toner charging be applied to the transfer device 50 as a transfer bias. Thereafter, the transfer medium 95 is separated from the photoconductor 10 to obtain a transfer image.

In addition, the toner remaining on the photoconductor 10 is retrieved into a toner retrieving chamber 62 in the cleaning device 60 by the cleaning blade 61 serving as a cleaning member.

It is possible to convey the retrieved toner to either or both of the developing agent accommodating unit 46 and the toner hopper 45 by a toner recycling device for reuse.

The image forming apparatus includes a plurality of the developing devices described above to sequentially transfer the toner images to the recording medium. Thereafter, the recording medium is conveyed to a fixing mechanism. The fixing mechanism may fix the toner with heat, etc. Alternatively, the plurality of the toner images are temporarily transferred to an intermediate transfer body and thereafter the thus-obtained toner image is transferred to the recording medium followed by fixing as described above.

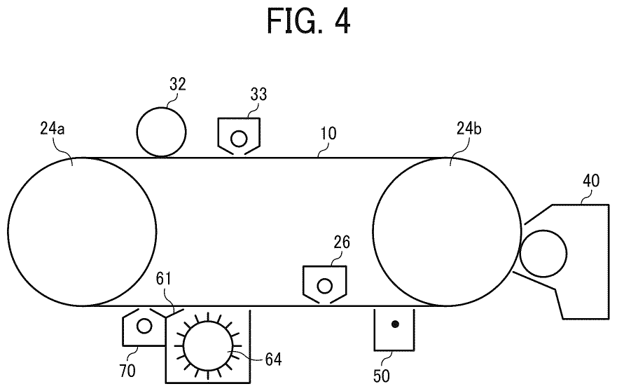

FIG. 4 is a diagram illustrating another example of the image forming apparatus for use in the present disclosure. The photoconductor 10 includes at least a photosensitive layer on an electroconductive substrate. The photoconductor 10 is driven by a drive rollers 24a and 24b, charged by the charging member 32, irradiated by the image irradiating system 33, developed by the developing device 40, transferred by the transfer device 50, irradiated with a pre-cleaning irradiating light source 26, cleaned by a brush cleaning device 64 and the cleaning blade 61, and discharged by the discharging lamp 70. In FIG. 4, the pre-cleaning irradiating light source 26 irradiates the photoconductor 10 from the substrate side thereof because the photoconductor 10 is transmissive in this case.

The image forming apparatus of the present disclosure includes an electrostatic latent image bearer, an electrostatic latent image forming device, a development device, and other optional devices.

The image forming method of the present disclosure includes forming an electrostatic latent image, developing the electrostatic latent image, and other optional processes.

The image forming method can be suitably conducted by the image forming apparatus. The electrostatic latent image can be suitably formed with the electrostatic latent image forming device. The electrostatic latent image can be suitably developed with the developing device. The other optional processes can be suitably conducted by the corresponding other optional devices.

The image forming apparatus more preferably includes an electrostatic latent image bearer, an electrostatic latent image forming device to form an electrostatic latent image on the electrostatic latent image bearer, a developing device to develop the electrostatic latent image on the electrostatic latent image bearer with toner to form a toner image, a transfer device to transfer the toner image onto the surface of a recording medium, and a fixing device to fix the toner image on the surface of the recording medium.

The image forming method more preferably includes forming an electrostatic latent image on an electrostatic latent image bearer, developing the electrostatic latent image formed on the electrostatic latent image bearer with toner to form a toner image, transferring the toner image formed on the electrostatic latent image bearer to the surface of a recording medium, and fixing the toner image transferred to the surface of the recording medium.

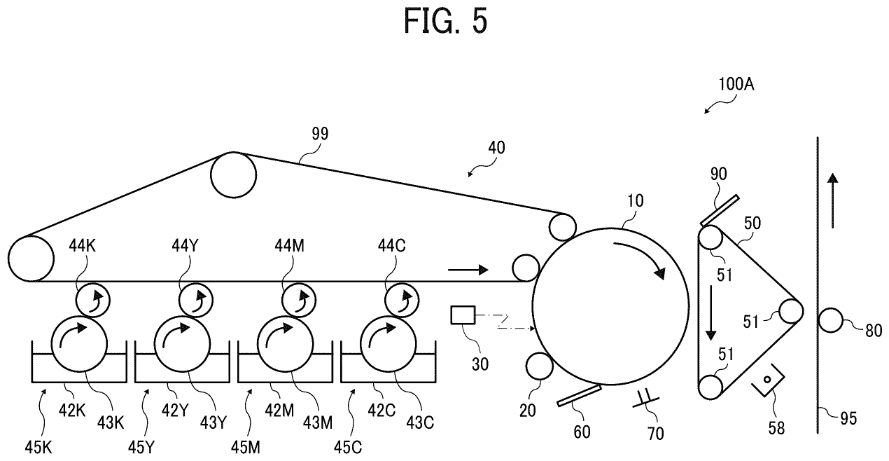

An aspect of the image forming apparatus of the present disclosure is described with reference to FIG. 5. A color image forming apparatus 100A illustrated in FIG. 5 includes a drum photoconductor 10 (hereinafter, also referred to as photoconductor 10) as the electrostatic latent image bearer, a charging roller 20 as the charging device, an irradiator 30 as the exposing device, the developing device 40 as the developing device, an intermediate transfer body 50, the cleaning device 60 as the cleaning device having a cleaning blade, and a discharging lamp 70 as the discharging device.

The intermediate transfer body 50 is a belt having an endless form and is designed to be movable in the direction indicated by the arrow by three rollers 51 which are disposed inside the intermediate transfer body 50 and stretches the intermediate transfer body 50. The three rollers 51 partially serves as a transfer bias roller to apply a transfer bias (primary transfer bias) to the intermediate transfer body 50. Around the intermediate transfer body 50 is disposed a cleaning device 90 including a cleaning blade. Around the intermediate transfer body 50, a transfer roller 80 is disposed as the transfer device capable of applying a transfer bias to transfer (secondary transfer) a developed image (toner image) onto the transfer medium 95 as a recording medium while facing the intermediate transfer body 50. Around the intermediate transfer body 50, a corona charger 58 to apply charges to the toner image on the intermediate transfer body 50 is disposed between the contact portion of the drum photoconductor 10 and the intermediate transfer body 50 and the contact portion between the intermediate transfer body 50 and the transfer medium 95 along the rotation direction of the intermediate transfer body 50.

The developing device 40 includes a developing belt 99 as the developing agent bearer, a black (Bk) developing unit 45 K, a yellow (Y) developing unit 45Y, a magenta (M) developing unit 45 M, a cyan (C) developing unit 45C, and a metallic (G) developing unit 45G, all of which are disposed around the developing belt 99. The black developing unit 45K includes a developing agent accommodating unit 42K, a developing agent supplying roller 43K, and a developing roller 44K. The yellow developing unit 45Y includes a developing agent accommodating unit 42Y, a developing agent supplying roller 43Y, and a developing roller 44Y. The magenta developing unit 45M includes a developing agent accommodating unit 42M, a developing agent supplying roller 43M, and a developing roller 44M. The cyan developing unit 45C includes a developing agent accommodating unit 42C, a developing agent supplying roller 43C, and a developing roller 44C. The yellow developing unit 45G includes a developing agent accommodating unit 42G, a developing agent supplying roller 43G, and a developing roller 44G. Further, the developing belt 99 takes an endless form, stretched around a plurality of belt rollers in a rotatable manner, and partially contacts with the electrostatic latent image bearer (drum photoconductor) 10.

The image forming method is specifically described below.

Image data sent to an image processing unit (hereinafter referred to as IPU) form image signals for each of five colors of yellow (Y), magenta (M), cyan (C), black (Bk), and metallic (G).

Thereafter, the image processing unit transmits each image signal of Y, M, C, Bk, and G to a writing unit 15. The writing unit modulates and scans the five laser beams for Y, M, C, K, and G, and the charging unit charges the drum photoconductor to sequentially form electrostatic latent images on the drum photoconductors. For example, the first drum photoconductor, the second drum photoconductor, the third drum photoconductor, the fourth drum photoconductor, and the fifth drum photoconductor respectively correspond to K, Y, M, C, and G.

Next, the developing unit as the developing device forms each color toner images on the drum photoconductor. In addition, the transfer sheet fed by the sheet feeding unit is conveyed on a transfer belt. The toner images on the drum photoconductors are sequentially transferred to the transfer sheet by transfer chargers.

After this transfer process, the transfer sheet is conveyed to a fixing unit, where the transferred toner image is fixed on the transfer sheet.

After the completion of the transfer system, the toner remaining on the drum photoconductor is removed by the cleaning device.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight rations in parts, unless otherwise specified.

### EXAMPLES

Next, the present disclosure is described in detail with reference to Examples and Comparative Examples but is not limited thereto. In the following Examples and Comparative Examples, “parts” represents “parts by mass” unless otherwise specified.

### Example 1

The present disclosure is described in detail based on the following Examples.

“Parts” represents parts by mass and “percent” represents percent by mass unless otherwise specified in the following description.

It is to be noted that it will be apparent to one of ordinary skill in the art that many suitable changes and modifications can be made to the Examples of the present invention described below to make other embodiments, these changes and modifications are within the scope of the present invention, and the following descriptions are merely examples in preferable embodiments of the present invention and are not limiting.

### Preparation of Amorphous Polyester Resin

The monomers shown in Table 1 and tetra-n-butoxytitanate as a condensation catalyst were loaded in a reaction vessel equipped with a cooling tube, a stirrer, and a nitrogen introduction tube. The mixture was allowed to react at 230 degrees Celsius for 6 hours under a nitrogen gas flow, with the generated water being removed during the process. Next, the mixture was reacted under a reduced pressure of 5 mmHg to 20 mmHg for 1 hour to obtain an amorphous polyester resin. In Table 1, “25 percent by mol” for bisphenol A (2,2) propylene oxide indicates the proportion in the alcohol component in the case where the acid component is 50 percent by mol and the alcohol component is 50 percent by mol.

TABLE 1

Monomer

| Acid component | Alcohol component | OH/COOH |
|---|---|---|
| Terephthalic acid | Bisphenol A (2,2) propylene | 1.1 |
| | oxide (25 percent by mol) | |
| | Bisphenol A (2,2) ethylene | |
| | oxide (25 percent by mol) | |

### Preparation of Crystalline Polyester Resin

Fumaric acid and 1,6-hexanediol were charged into a 5 L four-neck flask equipped with a nitrogen inlet tube, a dehydration tube, a stirrer, and a thermocouple, at an OH/COOH ratio of 0.9. The mixture was then reacted with titanium tetraisopropoxide (500 ppm relative to the resin components) at 180 degrees C. for 10 hours. Subsequently, the temperature was raised to 200 degrees C. and the reaction was continued for an additional 3 hours. The mixture obtained was then further reacted at a pressure of 8.3 kPa for 2 hours to obtain a crystalline polyester resin.

### Manufacturing of Base Toner Particle

The following materials were pre-mixed using a Henschel mixer (FM20B, available from Mitsui Miike Chemical Engineering Machinery Co., Ltd.), then melt-mixed at 120 degrees Celsius using a twin-screw kneader (PCM-30, available from Ikegai Corporation).
Amorphous polyester resin: 88.5 parts
Crystalline polyester resin 4.5
Styrene-α-methylstyrene copolymer (SA140, available from Kraton Corporation, Tg value of 87 degrees Celsius): 8.0 parts
Hydrocarbon wax (Fischer-Tropsch Wax FNP-0090, manufactured by NIPPON SEIRO CO., LTD.: 4.0 parts
Carbon black (#44, manufactured by Mitsubishi Chemical Corporation): 13.0 parts

### Pre-Mixing Conditions

The pre-mixing conditions were set as follows:

[1400 rpm, 1 min ON, 2 min OFF]×5 cycles

The obtained kneaded material was rolled to a thickness of 4.0 mm using a roller, then cooled to room temperature with a belt cooler, and coarsely pulverized with a hammer mill so that the average particle size was 200 to 300 μm. Next, the coarsely pulverized kneaded material was finely pulverized using a supersonic jet mill (Lab Jet, manufactured by Nippon Pneumatic Mfg. Co., Ltd.), and then classified with an air classifier (MDS-I, manufactured by Nippon Pneumatic Mfg. Co., Ltd.) while appropriately adjusting the louver opening so that the weight-average particle diameter fell within the range of 6.8±0.3 μm, thereby obtaining [Base Toner Particle 1].

It should be noted that although the catalog value of the glass transition temperature (Tg) of the styrene-α-methylstyrene copolymer (SA140, manufactured by Kraton), which is an aromatic petroleum resin, is 87 degrees Celsius, variations of about ±5 degrees Celsius occur depending on the production lot. Therefore, Tg value was measured in advance by the following measurement method. The same applies to Examples and Comparative Examples below.

### Measurement Method for Glass Transition Temperature (Tg) of Styrene-α-Methylstyrene Copolymer

Approximately 5.0 mg of the styrene-α methylstyrene copolymer (SA140, manufactured by Kraton), which is the target sample, was placed in an aluminum sample container. The sample container was then mounted on a holder unit and set in an electric furnace. Next, under a nitrogen atmosphere, the temperature was raised from −80 to 150 degrees Celsius at a heating rate of 10 degrees Celsius/min. From the obtained DSC curve, the glass transition temperature (Tg) of the styrene-α-methylstyrene copolymer was determined using the analysis program in the differential scanning calorimeter. The measured glass transition temperature (Tg) of the styrene-α-methylstyrene copolymer was 81 degrees Celsius.

### Preparation of Toner Developing Agent

To 100 parts by mass of the obtained base toner particles, 1 part by mass of metal oxide fine particles (HDK-2000, Clariant Ltd.) was added as an external additive and mixed by agitation using a Henschel mixer to produce an external additive-treated toner.

Then 5 parts by mass of the obtained external additive-treated toner and 95 parts by mass of a coated ferrite carrier were uniformly mixed at 48 rpm for 5 minutes using a Turbula mixer (manufactured by Willy A. Bachofen AG), thereby producing [Toner Developing Agent 1].

### Average Circularity

Using a flow-type particle image analyzer (Flow Particle Image Analyzer) FPIA-3000 (manufactured by Sysmex Corporation), 0.1 to 0.5 mL of an alkylbenzene sulfonate was added as a dispersant to 100 to 150 mL of water in a container from which foreign solid matter had been previously removed. Then approximately 0.1 to 0.5 g of the measurement sample was added, and the resulting suspension was dispersed for about 1 to 3 minutes using an ultrasonic disperser. The dispersion was adjusted to a concentration of 3,000 to 10,000 particles/μL, and the toner shape was measured using the above device. The results are shown in Table 4.

### Method of Measuring Aspect Ratio of Release Agent Domain

The long and short diameters of release agent domains present within [Base Toner Particle 1] were measured by observing the particle cross-section of [Base Toner Particle 1] using a transmission electron microscope, and the aspect ratio was calculated.

First, the particles of [Base Toner Particle 1] were sufficiently dispersed in a room-temperature-curable epoxy resin, then embedded in the epoxy resin, and the resin was fully cured. Subsequently, particle cross-sections of [Base Toner Particle 1] were prepared using an ultramicrotome (Ultrasonic), and staining was performed on a necessity basis using a combination of ruthenium tetroxide and osmium tetroxide. The cross sections were observed with a scanning transmission electron microscope (STEM) (such as LEM-2000, manufactured by Topcon, or JEM-2000FX, manufactured by JEOL), and images of the particle cross sections of [Base Toner Particle 1] were obtained at a magnification of 2,000×. From the obtained cross-sectional images of [Base Toner Particle 1], the long and short diameters of the release agent domains present in the toner particle cross section were determined.

For this calculation, an image analysis method using the “Azo-kun” image analysis software (registered trademark, manufactured by Asahi Kasei Engineering Corp.) with the tissue analysis technique was employed.

Specifically, 100 toner cross sectional images were selected. The analysis conditions were set as follows: number of tissues=3, binarization method=manual. The release agent domain regions were separated and identified from the total area of the toner cross section, and the long and short diameters of the release agent domains were calculated from the separated regions.

Based on the obtained long and short diameters of the release agent domains, the aspect ratio of the release agent domains was calculated according to the following Formula 1.

$$Aspect ratio = ( short diameter of release agent domain ) / ( long diameter of release agent domain ) \qquad Formula 1$$

### Measurement Result

Table 3 shows the average number of release agent domains having a long diameter of at least 400 nm and an aspect ratio of at most 0.7 in 100 toner particle cross sections and the average number of release agent domains having a long diameter of at least 400 nm and an aspect ratio of at most 0.5 in 100 toner particle cross sections.

### Low Temperature Fixability

The [Toner Developing Agent 1] obtained was placed in a Ricoh photocopier (RICOH IM C5510), available from Ricoh Co., Ltd., followed by image outputting. A solid image with a toner adhesion amount of 0.4 mg/cm² was formed on a recording medium, which was paper (Type 6200, manufactured by Ricoh Co., Ltd.), through the exposure, development, and transfer processes. The fixing line speed was set to 256 mm/sec. The fixing temperature was sequentially output in 2 degrees Celsius increments, and the lower limit temperature at which cold offset did not occur was measured. Based on the evaluation criterion below, low-temperature fixability was evaluated. The lower limit temperature at which cold offset does not occur is defined as the fixing lower limit temperature. The results are shown in Table 4. It is determined that a rating of A to C is sufficient for practical use.

### Evaluation Criterion on Low Temperature Fixability

A: lower than 120 degrees Celsius
B: 120 to lower than 125 degrees Celsius
C: 125 to lower than 130 degrees Celsius
D: not lower than 130 degrees Celsius

### Hot Offset Resistance

The [Toner Developing Agent 1] obtains was loaded into the housing unit of a photocopier (RICOH MPC 6003, manufactured by Ricoh Co., Ltd.), and a solid image was formed on a recording medium, which was paper (Type 6200, manufactured by Ricoh Co., Ltd.), so that the toner adhesion amount was 0.4 mg/cm².

The solid image was sequentially output at a linear fixing speed of 256 mm/s, a nipping width of the fixing device of 11 mm, and temperatures at 5 degrees Celsius intervals to determine the upper limit temperature below which hot offset did not occur. Hot offset resistance was evaluated according to the following evaluation criterion. The upper limit temperature at which hot offset does not occur is defined as the fixing upper limit temperature. The results are shown in Table 4. It is determined that a rating of A to C is sufficient for practical use.

### Evaluation Criterion

A: Upper limit of the fixing temperature is at least 200 degrees Celsius
B: Upper limit of the fixing temperature is from 190 to lower than 200 degrees Celsius
C: Upper limit of the fixing temperature is from 180 to lower than 190 degrees Celsius
D: Upper limit of the fixing temperature is lower than 180 degrees Celsius

### Filming Resistance (HH Environment)

The [Toner Developing Agent 1] obtained was placed into a photocopier (RICOH IM 9000, manufactured by Ricoh Co., Ltd.), and after running 200,000 sheets at an image area ratio of 1.0 percent under HH environment (a high-temperature and high-humidity environment) of 30 degrees Celsius, 90 percent), the filming condition on the photoconductor, serving as the electrostatic latent image bearer, was visually observed and evaluated based on the following evaluation criterion. The results are shown in Table 4. It is determined that a rating of A to C is sufficient for practical use.

### Evaluation Criterion of Filming

A: No toner deposits were present on the photoconductor.
B: Slight toner deposits were present on parts of the photoconductor, but there was no impact on the image.
C: Many toner deposits are present on the photoconductor, but there was no impact on the image.
D: Many toner deposits were present on the photoconductor, and image abnormalities were present.

### Filming Resistance (MM Environment)

The [Toner Developing Agent 1] obtained was placed into a photocopier (RICOH IM C9000, manufactured by Ricoh Co., Ltd.), and after running 200,000 sheets at an image area ratio of 1.0 percent under MM environment (a moderate-temperature and moderate-humidity environment) of 23 degrees Celsius, 50 percent), the filming condition on the photoconductor, serving as the electrostatic latent image bearer, was visually observed and evaluated based on the following evaluation criterion. The results are shown in Table 4. It is determined that a rating of A to C is sufficient for practical use.

### Evaluation Criterion of Filming

A: No toner deposits were present on the photoconductor.
B: Slight toner deposits were present on parts of the photoconductor, but there was no impact on the image.
C: Many toner deposits are present on the photoconductor, but there was no impact on the image.
D: Many toner deposits were present on the photoconductor, and image abnormalities were present.

### Example 2

The [Base Toner Particle 2] and [Toner Developing Agent 2] were prepared in the same manner as in Example 1 except that the temperature of the twin-screw kneader was changed from 120 to 130 degrees Celsius, the pre-mixing conditions were modified to [1400 rpm, 1 min on, 2 min off]×4 cycles, and the amount of styrene-α-methylstyrene copolymer (SA140, manufactured by Kraton) was changed from 8.0 to 7.0 parts, and the same measurements and evaluations as in Example 1 were performed.

The results are shown in Tables 3 and 4.

### Example 3

The [Base Toner Particle 3] and [Toner Developing Agent 3] were prepared in the same manner as in Example 1 except that the temperature of the twin-screw kneader was changed from 120 to 105 degrees Celsius, the pre-mixing conditions were modified to [1500 rpm, 1 min on, 2 min off]×6 cycles, and the amount of styrene-α-methylstyrene copolymer (SA140, manufactured by Kraton) was changed from 8.0 to 9.5 parts, and the same measurements and evaluations as in Example 1 were performed. The results are shown in Tables 3 and 4.

### Example 4

The [Base Toner Particle 4] and [Toner Developing Agent 4] were prepared in the same manner as in Example 1 except that the amount of hydrocarbon wax (FNP-0090, manufactured by Nippon Seiro Co., Ltd.) was changed in the pre-mixing process from 4.0 to 2.5 parts, and the same measurements and evaluations as in Example 1 were performed.

The results are shown in Tables 3 and 4.

### Example 5

The [Base Toner Particle 5] and [Toner Developing Agent 5] were prepared in the same manner as in Example 1 except that the amount of hydrocarbon wax (FNP-0090, manufactured by Nippon Seiro Co., Ltd.) was changed in the pre-mixing process from 4.0 to 5.5 parts, and the same measurements and evaluations as in Example 1 were performed. The results are shown in Tables 3 and 4.

### Example 6

The [Base Toner Particle 6] and [Toner Developing Agent 6] were prepared in the same manner as in Example 1 except that the pre-mixing conditions were modified to [1200 rpm, 1 min on, 2 min off]×4 cycles, and the same measurements and evaluations as in Example 1 were performed. The results are shown in Tables 3 and 4.

### Example 7

The [Base Toner Particle 7] and [Toner Developing Agent 7] were prepared in the same manner as in Example 1 except that the pre-mixing conditions were modified to [1000 rpm, 1 min on, 2 min off]×3 cycles, and the same measurements and evaluations as in Example 1 were performed. The results are shown in Tables 3 and 4.

### Example 8

The [Base Toner Particle 8] and [Toner Developing Agent 8] were prepared in the same manner as in Example 1 except that the wax was changed from hydrocarbon wax (FNP-0090, manufactured by Nippon Seiro Co., Ltd.) to rice brown wax (300 VITA, manufactured by Clariant), and the same measurements and evaluations as in Example 1 were performed. The results are shown in Tables 3 and 4.

### Comparative Example 1

The [Base Toner Particle 9] and [Toner Developing Agent 9] were prepared in the same manner as in Example 1 except that the temperature of the twin-screw kneader was changed from 120 to 140 degrees Celsius, the pre-mixing conditions were modified to [1400 rpm, 1 min on, 2 min off]×6 cycles, and the amount of styrene-α-methylstyrene copolymer (SA140, manufactured by Kraton) was changed from 8.0 to 12.0 parts, and the same measurements and evaluations as in Example 1 were performed. The results are shown in Tables 3 and 4.

### Comparative Example 2

The [Base Toner Particle 10] and [Toner Developing Agent 10] were prepared in the same manner as in Example 1 except that the temperature of the twin-screw kneader was changed from 120 to 100 degrees Celsius, the pre-mixing conditions were modified to [1400 rpm, 1 min on, 2 min off]×4 cycles, and the amount of styrene-α-methylstyrene copolymer (SA140, manufactured by Kraton) was changed from 8.0 to 4.0 parts, and the same measurements and evaluations as in Example 1 were performed. The results are shown in Tables 3 and 4.

### Comparative Example 3

The [Base Toner Particle 11] and [Toner Developing Agent 11] were prepared in the same manner as in Example 1 except that the amount of hydrocarbon wax (FNP-0090, manufactured by Nippon Seiro Co., Ltd.) was changed in the pre-mixing process from 4.0 to 2.0 parts, and the same measurements and evaluations as in Example 1 were performed. The results are shown in Tables 3 and 4.

### Comparative Example 4

The [Base Toner Particle 12] and [Toner Developing Agent 12] were prepared in the same manner as in Example 1 except that the amount of hydrocarbon wax (FNP-0090, manufactured by Nippon Seiro Co., Ltd.) was changed in the pre-mixing process from 4.0 to 6.0 parts, and the same measurements and evaluations as in Example 1 were performed. The results are shown in Tables 3 and 4.

The prescription and the pre-mix conditions for each of the base toner particles of Examples and Comparative Examples are shown in Table 2 below.

TABLE 2

| | Components of base toner particle | | | | |
|---|---|---|---|---|---|
| | Styrene-α- | | | | |
| Example No. | methylstyrene | | | Carbon | |
| Comparative | copolymer | Release Agent | | black | Other |
| Example No. | (parts) | Type | Parts | (parts) | components |
| Example 1 | 8.0 | Hydrocarbon | 4.0 | 13.0 | Amorphous |
| | | wax | | | polyester |
| Example 2 | 7.0 | Hydrocarbon | 4.0 | | resin: 88.5 |
| | | wax | | | Amorphous |
| Example 3 | 9.5 | Hydrocarbon | 4.0 | | polyester |
| | | wax | | | resin: 4.5 |
| Example 4 | 8.0 | Hydrocarbon | 2.5 | | Carbon |
| | | wax | | | black: 13.0 |
| Example 5 | 8.0 | Hydrocarbon | 5.5 | | |
| | | wax | | | |
| Example 6 | 8.0 | Hydrocarbon | 4.0 | | |
| | | wax | | | |
| Example 7 | 8.0 | Hydrocarbon | 4.0 | | |
| | | wax | | | |
| Example 8 | 8.0 | Rice brown | 4.0 | | |
| | | wax | | | |
| Comparative | 12.0 | Hydrocarbon | 4.0 | | |
| Example 1 | | wax | | | |
| Comparative | 4.0 | Hydrocarbon | 4.0 | | |
| Example 2 | | wax | | | |
| Comparative | 8.0 | Hydrocarbon | 2.0 | | |
| Example 3 | | wax | | | |
| Comparative | 8.0 | Hydrocarbon | 6.0 | | |
| Example 4 | | wax | | | |

| | Pre-mixing Conditions | |
|---|---|---|
| Example No. | Temperature | |
| Comparative | (degrees | |
| Example No. | Celsius) | Pre-mixing condition |
| Example 1 | 120 | [1400 rpm, 1 min ON, |
| | | 2 min OFF] × 5 cycles |
| Example 2 | 130 | [1400 rpm, 1 min ON, |
| | | 2 min OFF] × 4 cycles |
| Example 3 | 105 | [1500 rpm, 1 min ON, |
| | | 2 min OFF] × 6 cycles |
| Example 4 | 120 | [1400 rpm, 1 min ON, |
| | | 2 min OFF] × 5 cycles |
| Example 5 | 120 | [1400 rpm, 1 min ON, |
| | | 2 min OFF] × 5 cycles |
| Example 6 | 120 | [1200 rpm, 1 min ON, |
| | | 2 min OFF] × 4 cycles |
| Example 7 | 120 | [1000 rpm, 1 min ON, |
| | | 2 min OFF] × 3 cycles |
| Example 8 | 120 | [1400 rpm, 1 min ON, |
| | | 2 min OFF] × 5 cycles |
| Comparative | 140 | [1400 rpm, 1 min ON, |
| Example 1 | | 2 min OFF] × 6 cycles |
| Comparative | 100 | [1400 rpm, 1 min ON, |
| Example 2 | | 2 min OFF] × 4 cycles |
| Comparative | 120 | [1400 rpm, 1 min ON, |
| Example 3 | | 2 min OFF] × 5 cycles |
| Comparative | 120 | [1400 rpm, 1 min ON, |
| Example 4 | | 2 min OFF] × 5 cycles |

TABLE 3

| | | Average number of | Average number of |
|---|---|---|---|
| | | release agent domains | release agent domains |
| | | having a major axis of | having a major axis of |
| | | at least 400 nm and an | at least 400 nm and an |
| Example No. | Type of | aspect ratio of at most | aspect ratio of at most |
| Comparative | release | 0.7 in 100 toner particle | 0.5 in 100 toner particle |
| Example No. | agent | cross-sections. | cross-sections |
| Example 1 | Hydrocarbon | 5 | 3 |
| | wax | | |
| Example 2 | Hydrocarbon | 6 | 6 |
| | wax | | |
| Example 3 | Hydrocarbon | 4 | 1 |
| | wax | | |
| Example 4 | Hydrocarbon | 3 | 1 |
| | wax | | |
| Example 5 | Hydrocarbon | 6 | 6 |
| | wax | | |
| Example 6 | Hydrocarbon | 7 | 6 |
| | wax | | |
| Example 7 | Hydrocarbon | 8 | 7 |
| | wax | | |
| Example 8 | Rice brown | 5 | 3 |
| | wax | | |
| Comparative | Hydrocarbon | 1 | 1 |
| Example 1 | wax | | |
| Comparative | Hydrocarbon | 10 | 7 |
| Example 2 | wax | | |
| Comparative | Hydrocarbon | 1 | 1 |
| Example 3 | wax | | |
| Comparative | Hydrocarbon | 9 | 6 |
| Example 4 | wax | | |

TABLE 4

| | | | Filming | Filming | |
|---|---|---|---|---|---|
| | Low | Hot | resistance | resistance | |
| | temperature | offset | (HH | (MM | Average |
| | fixability | resistance | environment) | environment) | Circularity |
| Example 1 | A | A | A | A | 0.948 |
| Example 2 | A | A | C | B | 0.951 |
| Example 3 | A | C | A | A | 0.944 |
| Example 4 | A | C | A | A | 0.953 |
| Example 5 | A | A | C | C | 0.939 |
| Example 6 | A | B | C | B | 0.948 |
| Example 7 | A | B | C | C | 0.948 |
| Example 8 | A | A | B | B | 0.948 |
| Comparative | A | D | A | A | 0.935 |
| Example 1 | | | | | |
| Comparative | B | B | D | C | 0.952 |
| Example 2 | | | | | |
| Comparative | B | D | A | A | 0.953 |
| Example 3 | | | | | |
| Comparative | A | A | D | D | 0.938 |
| Example 4 | | | | | |

As described above, the toners in Examples 1 to 8 satisfy the following requirements defined in the present disclosure and therefore have practically sufficient properties. On the other hand, the toners in Comparative Examples 1 to 4 do not satisfy the following requirements and therefore do not have practically sufficient properties.

### Requirements:

(i) the average number of the domains of the release agent present per toner particle is 2 to 8; and (ii) each of the domains has a long diameter of at least 400 nm and an aspect ratio of at most 0.7 as calculated by Formula 1:

$$Aspect ratio = ( short diameter of release agent domain ) / ( long diameter of release agent domain ) \qquad Formula 1$$

The aspects of the present disclosure are, for example, as follows:

### Aspect 1.

A toner contains toner particles that contains a polyester resin, an aromatic petroleum resin, and a release agent, wherein cross sections of the toner particles observed with a scanning electron microscope have domains of the release agent that satisfy the following requirements (i) and (ii):
(i) the average number of the domains present per toner particle is 2 to 8; and
(ii) each of the domains has a long diameter of at least 400 nm and an aspect ratio of at most 0.7 as calculated by Formula 1:

$$Aspect ratio = ( short diameter of domain ) / ( long diameter of domain ) . \qquad Formula 1$$

### Aspect 2.

The toner according to Aspect 1 mentioned above, wherein the average number of the domains present per toner particle is 2 to 5 and each of the domains has an aspect ratio of at most 0.5.

### Aspect 3

The toner according to Aspect 1 or 2 mentioned above, wherein the toner has a content of the aromatic petroleum resin of 7 to 9.5 parts by mass based on 100 parts by mass of a total content of the polyester resin, the release agent, and the aromatic petroleum resin.

### Aspect 4.

The toner according to any one of Aspects 1 to 3 mentioned above, wherein the release agent contains a hydrocarbon wax.

### Aspect 5.

The toner according to any one of Aspects 1 to 4 mentioned above, wherein the aromatic petroleum resin has a glass transition temperature of 70 to 90 degrees Celsius.

### Aspect 6

The toner according to any one of Aspects 1 to 5 mentioned above has an average circularity of 0.93 to 0.96.

### Aspect 7

A developing agent contains the toner of any one of Aspects 1 to 6 mentioned above and a carrier.

### Aspect 8

A toner accommodating unit contains the toner of any one of Aspects 1 to 6 mentioned above and a container containing the toner.

### Aspect 9

An image forming apparatus includes an electrostatic latent image bearer, an electrostatic latent image forming device to form an electrostatic latent image on the electrostatic latent image bearer, a developing device to develop the electrostatic latent image on the electrostatic latent image bearer with the toner of any one of Aspects 1 to 6 mentioned above to form a toner image, a transfer device to transfer the toner image onto a surface of a recording medium, and a fixing device to fix the toner image on the surface of the recording medium.

### Aspect 10

An image forming method includes forming an electrostatic latent image on an electrostatic latent image bearer, developing the electrostatic latent image formed on the electrostatic latent image bearer with the toner of any one of Aspects 1 to 6 mentioned above to form a toner image on the electrostatic latent image bearer, transferring the toner image formed on the electrostatic latent image bearer to a surface of a recording medium, and fixing the toner image on the surface of the recording medium.

### Aspect 11

A method of producing a printed material includes forming an image on a recording medium with the image forming apparatus of Aspect 9 mentioned above to produce the printed material.

### Aspect 12

A method of manufacturing the toner of any one of Aspects 1 to 6 mentioned above, includes adding 7 to 9.5 parts by mass of the base toner particle to 100 parts by mass of the base toner particle to manufacture a base toner particle containing the polyester resin and the aromatic petroleum resin.

The above-described embodiments are illustrative and do not limit the present invention. Thus, numerals additional modifications and variations are possible in light of the above-teachings. For example, elements and/or features of difference illustrative embodiments may be combined with each other and/or substituted for each other within the scope of the present invention. Any one of the above-described operations may be performed in various other ways, for example, in an order difference from the one described above.

1. A toner comprising:
toner particles comprising:
a polyester resin;
an aromatic petroleum resin; and
a release agent,
wherein cross sections of the toner particles observed with a scanning electron microscope have domains of the release agent that satisfy the following requirements (i) and (ii):
(i) an average number of the domains present per toner particle is 2 to 8; and
(ii) each of the domains has a long diameter of at least 400 nm and an aspect ratio of at most 0.7 as calculated by Formula 1:
$$Aspect ratio = ( short diameter of domain ) / ( long diameter of domain ) . \qquad Formula 1$$

2. The toner according to claim 1,
wherein the average number of the domains present per toner particle is 2 to 5,
wherein each of the domains has an aspect ratio of at most 0.5.

3. The toner according to claim 1,
wherein the toner has a content of the aromatic petroleum resin of 7 to 9.5 parts by mass based on 100 parts by mass of a total content of the polyester resin, the release agent, and the aromatic petroleum resin.

4. The toner according to claim 1,
wherein the release agent comprises a hydrocarbon wax.

5. The toner according to claim 1,
wherein the aromatic petroleum resin has a glass transition temperature of 70 to 90 degrees Celsius.

6. The toner according to claim 1, having an average circularity of 0.93 to 0.96.

7. A developing agent comprising:
the toner of claim 1; and
a carrier.

8. Atoner accommodating unit comprising:
the toner of claim 1; and
a container containing the toner.

9. An image forming apparatus comprising:
an electrostatic latent image bearer;
an electrostatic latent image forming device to form an electrostatic latent image on the electrostatic latent image bearer;
a developing device to develop the electrostatic latent image on the electrostatic latent image bearer with the toner of claim 1 to form a toner image;
a transfer device to transfer the toner image onto a surface of a recording medium, and
a fixing device to fix the toner image on the surface of the recording medium.

10. An image forming method comprising:
forming an electrostatic latent image on an electrostatic latent image bearer;
developing the electrostatic latent image formed on the electrostatic latent image bearer with the toner of claim 1 to form a toner image on the electrostatic latent image bearer;
transferring the toner image formed on the electrostatic latent image bearer to a surface of a recording medium; and
fixing the toner image on the surface of the recording medium.

11. A method of producing a printed material comprising:
forming an image on a recording medium with the image forming apparatus of claim 9 to produce the printed material.

12. A method of manufacturing the toner of claim 1, comprising:
adding 7 to 9.5 parts by mass of the base toner particle to 100 parts by mass of the base toner particle to manufacture a base toner particle containing the polyester resin and the aromatic petroleum resin.
